(19) United States
(12) Patent Application Publication
(10) Pub. No.: US 2025/0317750 A1
(43) Pub. Date: Oct. 9, 2025

(54) SYSTEM AND METHOD FOR RADIO NETWORK PLANNING AND DEPLOYMENT

(71) Applicant: JIO PLATFORMS LIMITED, Ahmedabad (IN)

(72) Inventors: Haresh B AMBALIYA, Amreli (IN); Sundaresh SANKARAN, West Mumbai (IN); Sandeep RAWAT, Kotdwara (IN); Farsana C S, Thrissur (IN); Dharmesh A CHITALIYA, Dombivali (IN); Vikram SINGH, Mumbai (IN); Aayush BHATNAGAR, Navi Mumbai (IN); Manoj SHETTY, Mumbai (IN); Makarand DERE, Panvel (IN); Himanshu PATEL, Navi Mumbai (IN); Manish Kumar PATEL, Indore (IN); Pradeep Kumar BHATNAGAR, Navi Mumbai (IN)

(73) Assignee: JIO PLATFORMS LIMITED, Ahmedabad (IN)

(21) Appl. No.: 18/881,612

(22) PCT Filed: Feb. 22, 2024
(86) PCT No.: PCT/IN2024/050196

§ 371 Date: Jan. 6, 2025

(30) Foreign Application Priority Data
Feb. 24, 2023 (IN) 202321012786

(51) Int. Cl. H04W 16/18; H04B 17/309; H04B 17/318; H04L 41/16; H04L 41/5009

(52) U.S. Cl. CPC H04W 16/18; H04B 17/328; H04B 17/346; H04L 41/16; H04L 41/5009

(57) ABSTRACT

The present disclosure provides a system and a method radio network planning and deployment. The system provides an end to end (E2E) automation for network planning where nominals are auto generated using 4G crowdsource data. The system provides a strategy based nominal generation to cover key geographical areas. Further, the system enables auto validation of generated nominals based on strategy inputs and capacity inputs to generate an optimal list of site and cell configurations for network planning.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for network planning in a telecommunications network. More particularly, the present disclosure relates to a system and a method for radio network planning and deployment that automates an entire process of network planning. Further, the system and method for radio network planning and deployment provides an end to end (E2E) solution that employs unique sets of web applications for automated 5G planning and deployment.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

5G networks are utilized by industries providing a high bandwidth, an ultra-low latency and a massive internet of things (IoT) deployment. A fifth-generation cellular network provides a range of services broadly categorized into an enhanced mobile broadband (eMBB), an ultra-reliable, a low-latency communication (uRLLC), and a massive machine type communication (mMTC). Approximately 4 million cell sites radiating 4G networks have been deployed worldwide for providing broadband services. Every service type implements different design targets, hence planning and deployment for each service type is tailored for a target service. Hence, 5G networks may be utilized for providing a higher bandwidth, an ultra-low latency while providing broadband services. Additionally, 5G networks may also be used for a massive internet of things (IoT) deployment.

Conventionally, a task of network planning is performed by hundreds of engineers using desktop-based tools, which involve huge man-hours for collecting data and preprocessing. Additional limitations and challenges pertaining to undefined planning processes, crowdsource data, and inability of scaling may be observed. Further, a siloed approach and a steep learning curve may be required for network planning. Also, challenges in storing and performing spatial queries on geo datasets such as fiber, hotspots, and a point of interest (POI) may be encountered after data collection.

With wide ranges of possible 5G uses cases aimed to connect millions of devices and humans using higher frequency bands, a conventional approach may be insufficient to meet the necessary requirements related to delivery of broadband services. Further, multiple iterations, planning to get an optimal site plan, a cell configuration designed for a given coverage, and a capacity criterion may be complex and cumbersome to implement. Further, planning of any cellular network may require extensive paperwork and simulation that may be complex during implementation.

There is, therefore, a need in the art to provide a system and a method that can mitigate the problems associated with the prior arts.

### SUMMARY

In an exemplary embodiment, a method for performing network planning and deployment is described. The method comprises receiving a plurality of inputs from a nominal generation (NG) strategy module and a NG capacity module and generating a plurality of nominals based on the plurality of inputs from the NG strategy module and the NG capacity module using an artificial intelligence (AI) engine. The plurality of nominals includes a plurality of site locations. The method comprises sending the plurality of nominals to a nominal validation (NV) and performing validation of the plurality of nominals. The method comprises estimating azimuth for each of the plurality of validated nominals and obtaining a plurality of sites from the estimated azimuth. The method further comprises selecting a plurality of optimized sites from the plurality of sites obtained based on the estimated azimuth and deploying a network on the selected optimized sites. The selected optimized sites have optimal values of reference signal received power (RSRP) and a signal to interference and noise ratio (SINR), an optimal count of sites with optimized tilt and azimuth.

In some embodiments, the plurality of inputs from the NG capacity includes radio frequency (RF) data obtained from a plurality of user equipment (also referred to as crowdsourced RF data), customer device information, building data, fibre route, landmarks, a plurality of places of interest and performance of key point index (KPIs). The KPIs comprises RSRP and SINR.

In some embodiments, the plurality of inputs from the NG strategy includes a plurality of user-focused strategies, a plurality of cell-focused strategies, a plurality of area-focused strategies, a plurality of building and point of interest (POI) focused strategies. The plurality of user-focused strategies includes high-tariff, mid-range tariff, premium handset users, mid-range handset users, customers experience. The plurality of cell-based strategies includes dead cell, ICU cell, hospitalized cells, sick cells, active UE count. The plurality of area-focused strategies include morphology as dense urban, urban, sub-urban, rural and rail/road network as major roads, railway, lines, highways. The plurality of building and POI focused strategies include commercial, residential, high value buildings, POI type such as places of worships, hotels, public services, transport.

In some embodiment, for performing the nominal validation method comprises processing the plurality of capacity data and strategy data, a target area and the KPI to generate cell level data for each of the nominals. Generation of cell level data comprises at least in part setting of height, azimuth, tilt of cell. The method further comprises creating traffic map for the nominals; and identifying validated nominals based on the cell level data. The validated nominals comprise set of optimal sites and cell configuration.

In some embodiment, for estimating azimuth method comprises drawing a plurality of points on the site with distance equal to cell radius on an interface and connecting each of the plurality of points with a nominal center on the interface. The method further comprises calculating minimum and maximum angle between two points lines and determining average of the calculated minimum and maximum angle. The average of the minimum and maximum angle is azimuth of sector.

In some embodiment, for obtaining the plurality of optimized sites method comprises obtaining sites to be optimized from the plurality of sites and iterating each site from the sites to be optimized. The method further comprises estimating coverage gain based on the RSPR and the SINR and ordering sites based on the coverage gain inside the target area. The method comprises prioritizing the sites located in a high traffic density area and selecting the sites upto a point defined RSRP and SINR targets are achieved. The selected sites are optimized sites.

In some embodiment, deploying advanced generation network on the selected optimum sites over existing generation infrastructure or as a new site location. The advanced generation network comprises fifth generation (5G) and existing generation comprises fourth generation (4G).

In some embodiment, on selecting the plurality of optimized sites to deploy the network, deciding a plurality of orientations and a plurality of parameters for the sites. The plurality of orientations includes cell radius, cell range, and grid counts. The plurality of parameters includes azimuth, tilt, height, and power.

In another exemplary embodiment, a system for performing network planning and deployment is described. The system comprising a nominal generation (NG) strategy module and a NG capacity module, an artificial intelligence (AI) engine, a processing engine and a nominal validation (NV) module, the NG strategy module and the NG capacity module configured to provide a plurality of inputs to the AI engine. The AI engine configured to generate a plurality of nominals based on the plurality of inputs received from the NG strategy module and the NG capacity module. The plurality of nominals includes a plurality of site locations. The AI engine configured to send the plurality of nominals to a nominal validation (NV) module. The NV module configured to perform validation of the plurality of nominals. The processing engine configured to estimate azimuth for each of the plurality of validated nominals and obtain a plurality of sites from the estimated azimuth. The processing engine is further configured to select a plurality of optimized sites form the plurality of sites obtained based on the estimated azimuth and deploy a network on the selected optimized sites. The selected optimized sites have optimal values of reference signal received power (RSRP) and a signal to interference and noise ratio (SINR), an optimal count of sites with optimized tilt and azimuth.

In some embodiments, the plurality of inputs from the NG capacity includes crowdsourced radio frequency (RF) data, customer device information, building data, fibre route, landmarks, a plurality of places of interest and performance of key point index (KPIs).

In some embodiments, the plurality of inputs from the NG strategy includes a plurality of user-focused strategies, a plurality of cell-focused strategies, a plurality of area-focused strategies, a plurality of building and point of interest (POI) focused strategies. The plurality of user-focused strategies includes high-tariff, mid-range tariff, premium handset users, mid-range handset users, customers experience. The plurality of cell-based strategies includes dead cell, ICU cell, hospitalized cells, sick cells, active UE count. The plurality of area-focused strategies include morphology as dense urban, urban, sub-urban, rural and rail/road network as major roads, railway, lines, highways. The plurality of building and POI focused strategies include commercial, residential, high value buildings, POI type such as places of worships, hotels, public services, transport. In some embodiment, the NV module configured to process the plurality of capacity data and strategy data, a target area and the KPI to generate cell level data for each of the nominals. The generation of cell level data comprises at least in part setting of height, azimuth, tilt of cell. The NV module configured to create traffic map for the nominals and identify validated nominals based on the cell level data. The validated nominals comprise set of optimal sites and cell configurations.

In some embodiment, for estimating azimuth, the processing engine configured to draw a plurality of points on the site with distance equal to cell radius on an interface and connect each of the plurality of points with a nominal center on the interface. The processing engine configured to calculate minimum and maximum angle between two points lines and determine average of the calculated minimum and maximum angle. The average of the minimum and maximum angle is azimuth of sector.

In some embodiment, for obtaining the plurality of optimized sites, the processing module is configured to obtain sites to be optimized from the plurality of sites and iterate each site from the sites to be optimized. The processing module is configured to estimate coverage gain based on the RSPR and the SINR and order sites based on the coverage gain inside the target area. The processing module is configured to prioritize the sites located in a high traffic density area and select the sites upto a point defined RSRP and SINR targets are achieved. The selected sites are optimized sites.

In some embodiments, advanced generation network is deployed on the selected optimum sites over existing generation infrastructure or as a new site location. The advanced generation network is fifth generation (5G), and above, and existing generation is fourth generation (4G).

In some embodiments, the system is further configured to decide a plurality of orientations and a plurality of parameters for the sites on selecting the plurality of optimized sites to deploy the network. The plurality of parameters includes azimuth, tilt, height, and power. The plurality of orientations includes cell radius, cell range, and grid counts.

The foregoing general description of the illustrative embodiments and the following detailed description thereof are merely exemplary aspects of the teachings of this disclosure and are not restrictive.

### OBJECTS OF THE INVENTION

Some of the objects of the present disclosure, which at least one embodiment herein satisfies are listed herein below.

It is an object of the present disclosure to provide a system and a method that utilizes a cloud native architecture which eliminates a traditional desktop-based approach with new innovative and automated planning using radio application programming interfaces (APIs) hosted on a centralized infrastructure.

It is an object of the present disclosure to provide a system and a method that generates an optimal planning output and multiple network insights in a time bound manner for making quick business decisions regarding network planning.

It is an object of the present disclosure to provide a system and a method that provides an end to end (E2E) solution that employs unique sets of web applications for automated 5G planning and deployment.

It is an object of the present disclosure to provide a system and a method that provides cellular planning which touches all requirements from a network capacity/strategic point of view and further generates site locations/cell configurations that auto fine-tuned using a radio predictive engine.

It is an object of the present disclosure to provide a system and a method that automates an entire process of ingesting huge crowdsource data, geospatial data, and performs predictions and analysis for generating optimal sites associated with network planning.

It is an object of the present disclosure to provide a system and a method for enhancing the network planning and optimization.

It is an object of the present disclosure to enhance the user experience in a telecommunications network.

It is an object of the present disclosure to optimize network deployment and infrastructure related costs.

It is an object of the present disclosure to improvise the network system of an area.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (110), in accordance with an embodiment of the present disclosure.

FIG. 2 illustrates an exemplary representation (200) of a proposed system (110), in accordance with an embodiment of the present disclosure.

FIG. 3A-3M illustrates an exemplary end to end (E2E) automated system and method (300) for generating a network plan, in accordance with an embodiment of the present disclosure.

FIGS. 4A-4E illustrate exemplary end to end (E2E) 5G nominal planning flow (400) of the system (110), in accordance with embodiments of the present disclosure.

FIG. 5 illustrates an exemplary process (500) for the network deployment, in accordance with an embodiment of the present disclosure.

FIG. 6 illustrates an exemplary computer system (600) in which or with which the proposed system (110) may be implemented, in accordance with an embodiment of the present disclosure.

The foregoing shall be more apparent from the following more detailed description of the disclosure.

### LIST OF REFERENCE NUMERALS

100—Network architecture
200—A system
300A—Flow diagram
300B—Flow diagram
300C—Flow diagram
300D—Flow diagram
300E-1—Flow diagram
300E-2—Triggering NG_Strategy job
300E-3—Output from NG_Strategy
300F—Flow diagram
300G—Flow diagram
300H-1—Deployment strategy—5G ODSC
300H-2—Flow diagram
300I—Flow diagram
300J-1—Flow diagram
300J-2—Selecting the Capacity/Strategy Projects from UI
300K-1—Target Area and Target KPI
300K-2—Flow diagram
300L—User interface (UI)-nominal validation edit
300M—Flow diagram
400—Flow diagram
400D—A sample smart query window
400E—A plurality of stages and their description
500—Flow diagram
600—A computer system
610—External storage device
620—Bus
630—Main memory
640—Read only memory
650—Mass storage device
660—Communication port(s)
670—Processor

### BRIEF DESCRIPTION OF THE INVENTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

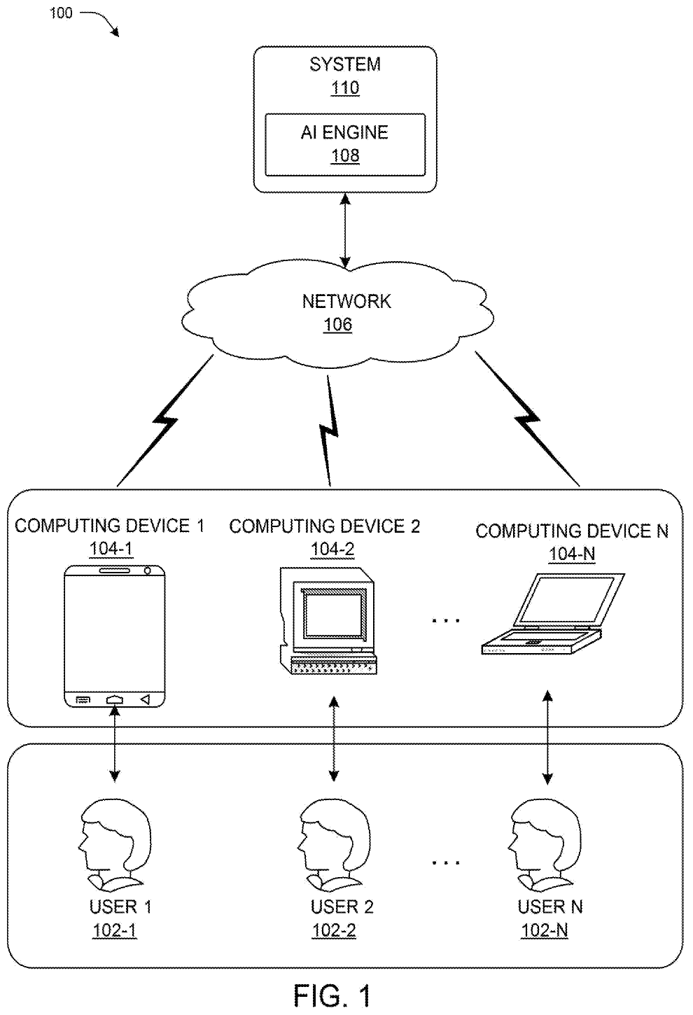

The various embodiments throughout the disclosure will be explained in more detail with reference to FIGS. 1-6.

FIG. 1 illustrates an exemplary network architecture (100) of a proposed system (110), in accordance with an embodiment of the present disclosure. As illustrated in FIG. 1, one or more user equipment (UE) (104-1, 104-2 . . . 104-N) may be connected to the proposed system (110) through a network (106). A person of ordinary skill in the art will understand that the one or more user equipments (104-1, 104-2 . . . 104-N) may be collectively referred as user equipments (UE's) (104) and individually referred as user equipment (UE) (104). One or more users (102-1, 102-2 . . . 102-N) may operate the UE (104) for providing a plurality of source data. A person of ordinary skill in the art will understand that the one or more users (102-1, 102-2 . . . 102-N) may be collectively referred as users (102) and individually referred as user (102). An artificial intelligence (AI) engine (108) may be configured in the system (110) that may auto generate a plurality of nominals or site locations based on the inputs provided by the users (102).

In an embodiment, the UE (104) may include, but not be limited to, a mobile, a laptop, etc. Further, the UE (104) may include one or more in-built or externally coupled accessories including, but not limited to, a visual aid device such as a camera, audio aid, microphone, or keyboard. Further, the UE (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a user such as a touchpad, touch-enabled screen, electronic pen, and the like may be used. In an embodiment, users/customers may submit their complaints through the UE's (104) as shown in FIG. 1.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

In an embodiment, the system (110) may utilize the plurality of source data and generate capacity grids for a geographical location. Further, the system (110) may auto generate the plurality of nominals or site locations based on the capacity grids.

In an embodiment, the system (110) may generate one or more strategy-based nominals based on a plurality of strategy inputs such as fiber, boundary, rail, roads, building, key landmark areas, town and village boundary etc.

In an embodiment, the system (110) may automatically generate validation of the plurality of nominals based on the plurality of strategy inputs and capacity inputs to further generate an optimal list of site and cell configurations.

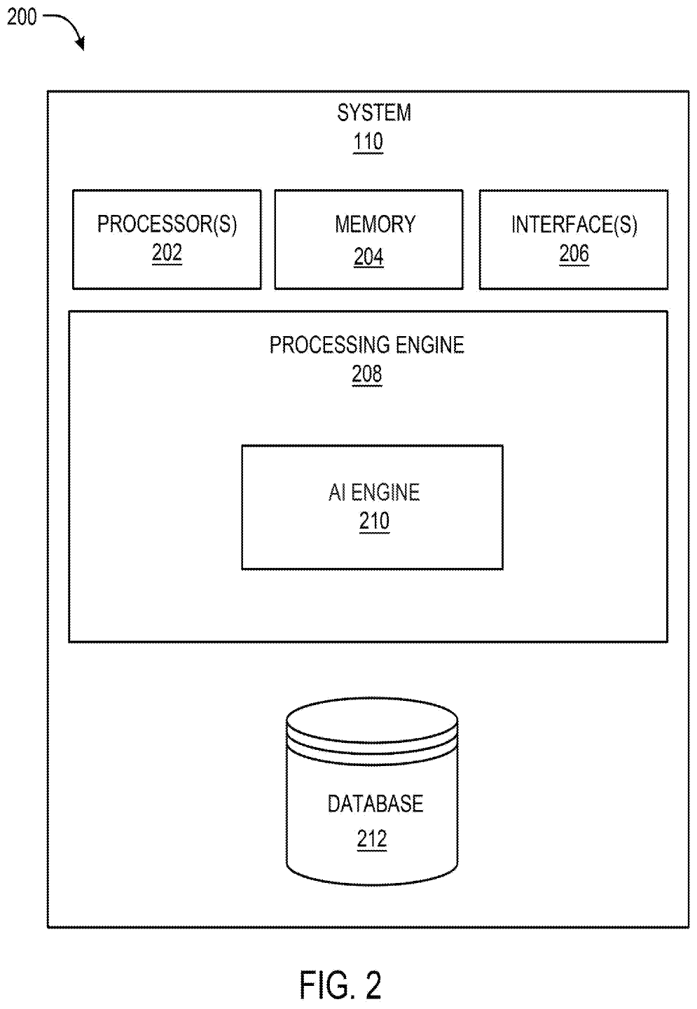

FIG. 2 illustrates an exemplary representation (200) of a proposed system (106), in accordance with an embodiment of the present disclosure.

Referring to FIG. 2, the system (110) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (106). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output devices (I/O), storage devices, and the like. The interface(s) (206) may facilitate communication through the system (110). The interface(s) (206) may also provide a communication pathway for one or more components of the system (110). Examples of such components include, but are not limited to, processing engine(s) (208), an artificial intelligence (AI) engine (210), and a database (212). A person skilled in the art may appreciate that the AI engine (210) may be similar to the AI engine 108 of FIG. 1 in its functionality.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive a plurality of source data from the users (102) and generate capacity grids for a geographical location. The processor (202) may store the received plurality of source data in the database (212). Further, the processor (202) may auto generate a plurality of nominals or site locations based on the capacity grids.

In an embodiment, the processor (202) may generate one or more strategy-based nominals based on a plurality of strategy inputs such as fiber, boundary, rail, roads, building, key landmark areas, town and village boundary etc.

In an embodiment, processor (202) may automatically generate validation of the plurality of nominals based on the plurality of strategy inputs and capacity inputs to further generate an optimal list of site and cell configurations.

The plurality of strategy inputs comprises user-focused strategies, cell-focused strategies, area-focused strategies and building and places of interests (POIs) focused strategies. The user-focused strategies comprise tariff (e.g., high-tariff users, mid-range users), user's device cost (e.g., premium handset users, mid-range handset users), customer's experience (e.g., poor, average, good). The cell-focused strategies comprise cell health, active UE count. The area-focused strategies comprise morphology (e.g., dense urban, urban, sub-urban, rural) and rail/road network (e.g., major roads, railway lines, highways). The building and places of interest (POI) strategies comprise building type (e.g., commercial, residential, high value buildings) and POI type include (e.g., places of worship, hotels, public services, transport, etc.).

The plurality of capacity inputs comprises crowdsourced RF data (RF data obtained from plurality of user equipment), performance key point indicators (KPIs), customer device information, building data, fibre route, landmarks and places of interest.

In an embodiment, the AI engine (210) may auto generate a plurality of nominals or site locations based on the inputs provided by the users (102).

In an embodiment, the AI engine (210) may utilize optimization for cell planning and generate the one or more strategy-based nominals.

In an embodiment, the system (110) may generate high-level input metrics based on the plurality of source data provided by the users (102).

In an embodiment, the generated high-level details of inputs metrics based on the plurality of source data, may be utilized in planning of the network.

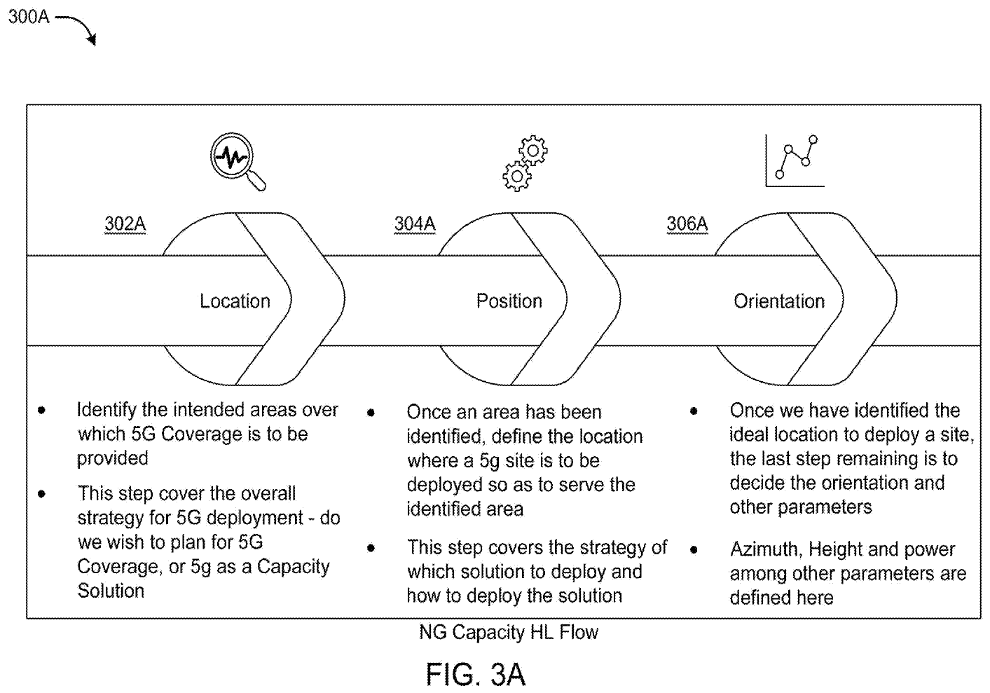

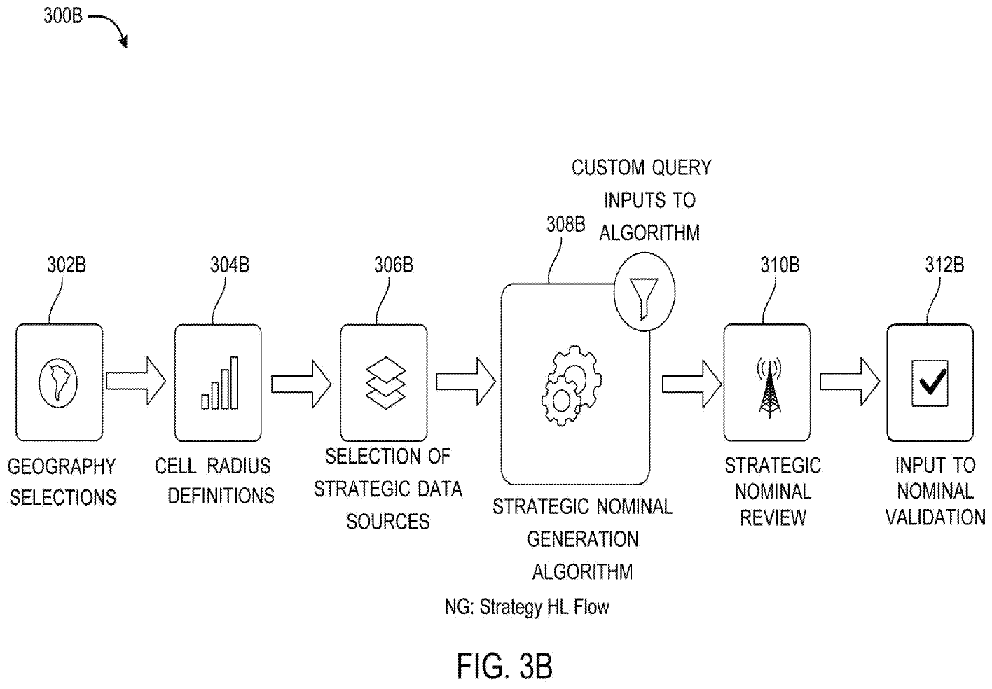

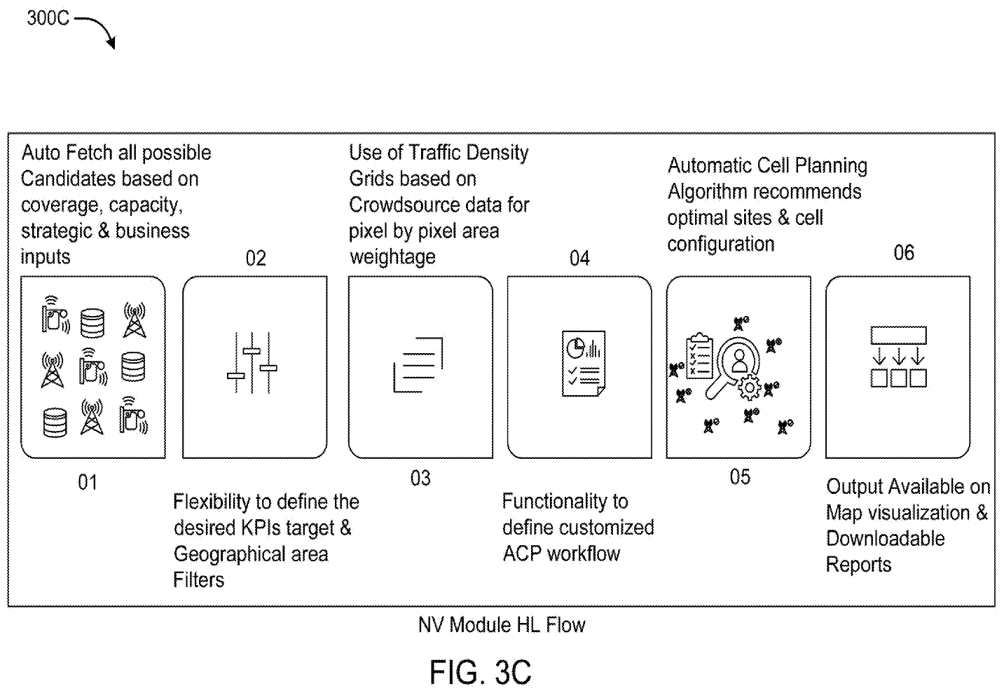

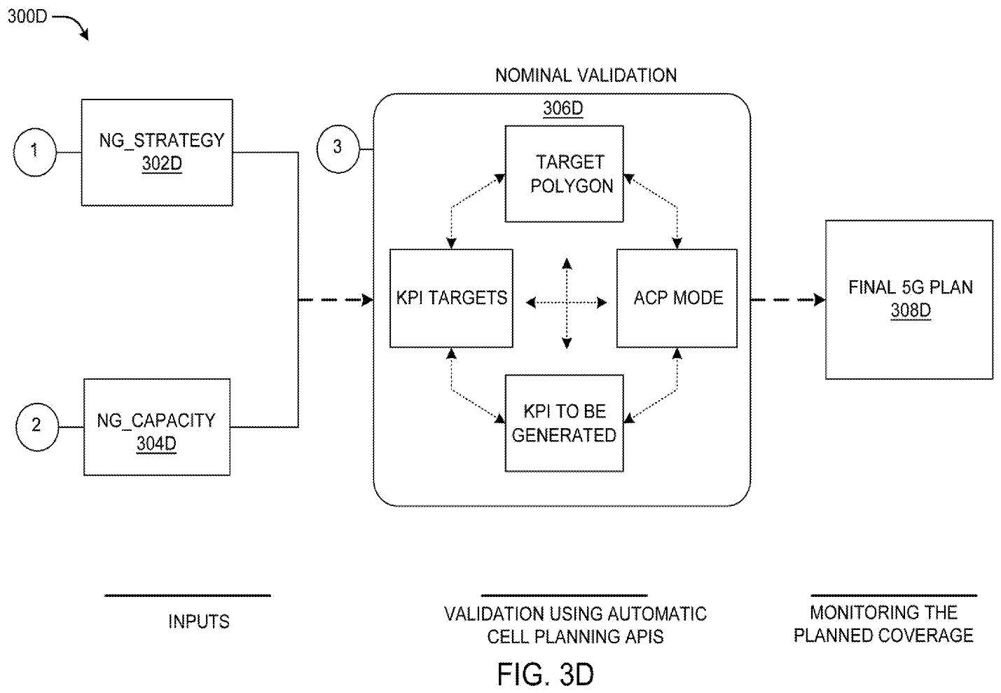

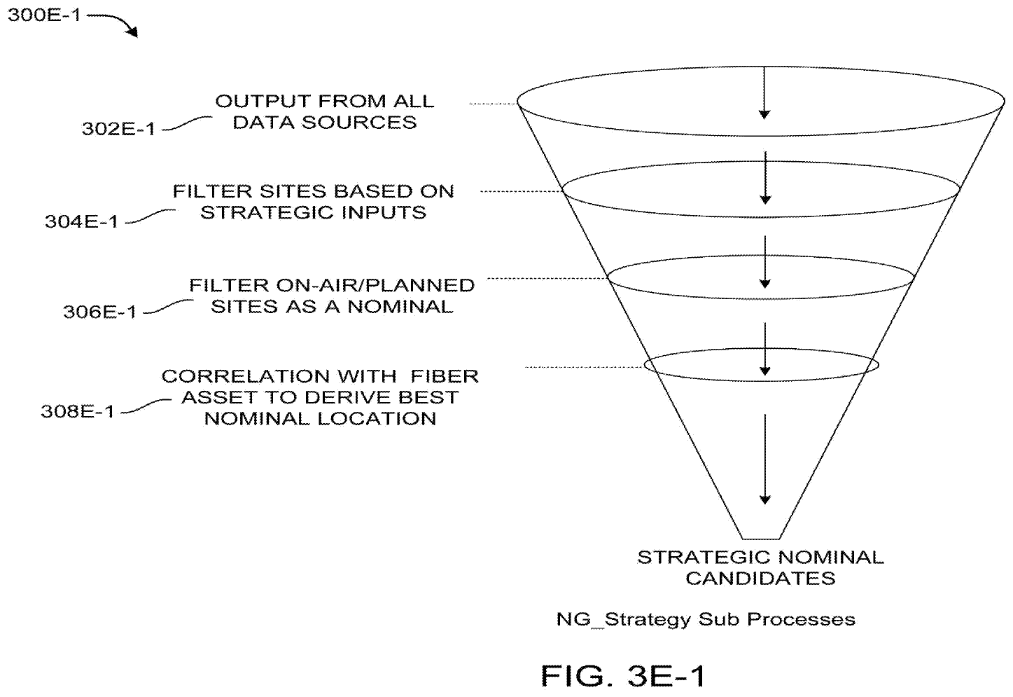

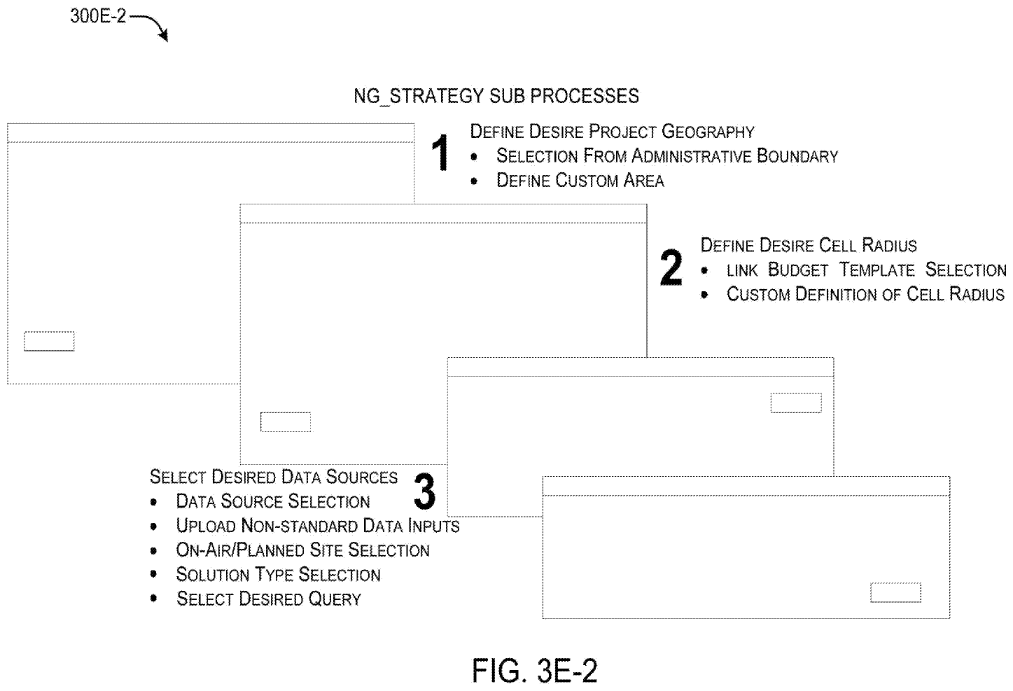

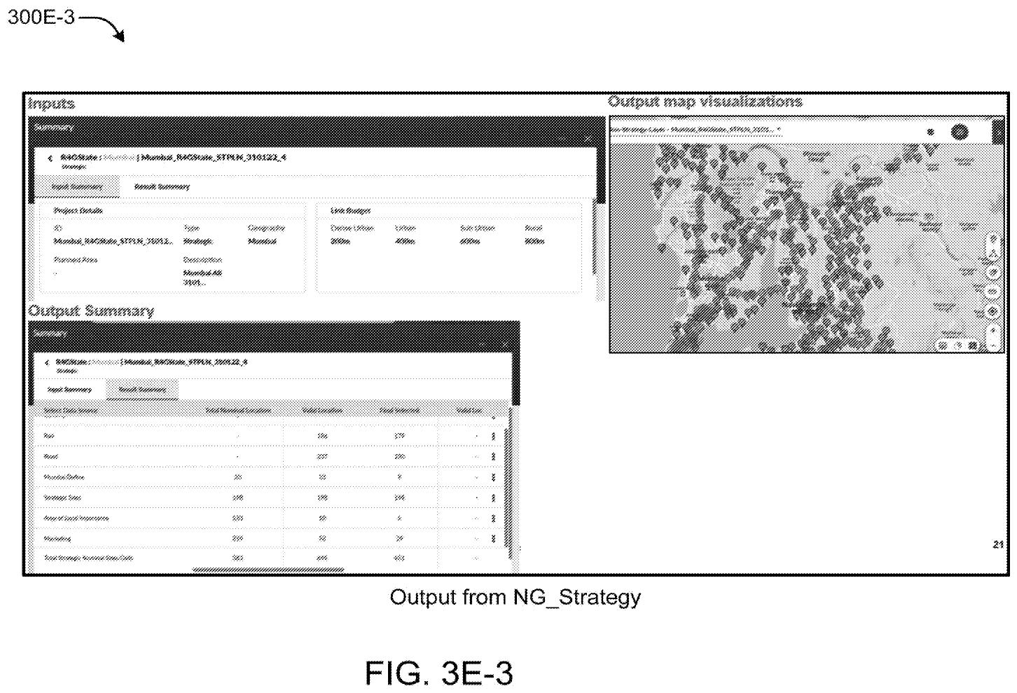

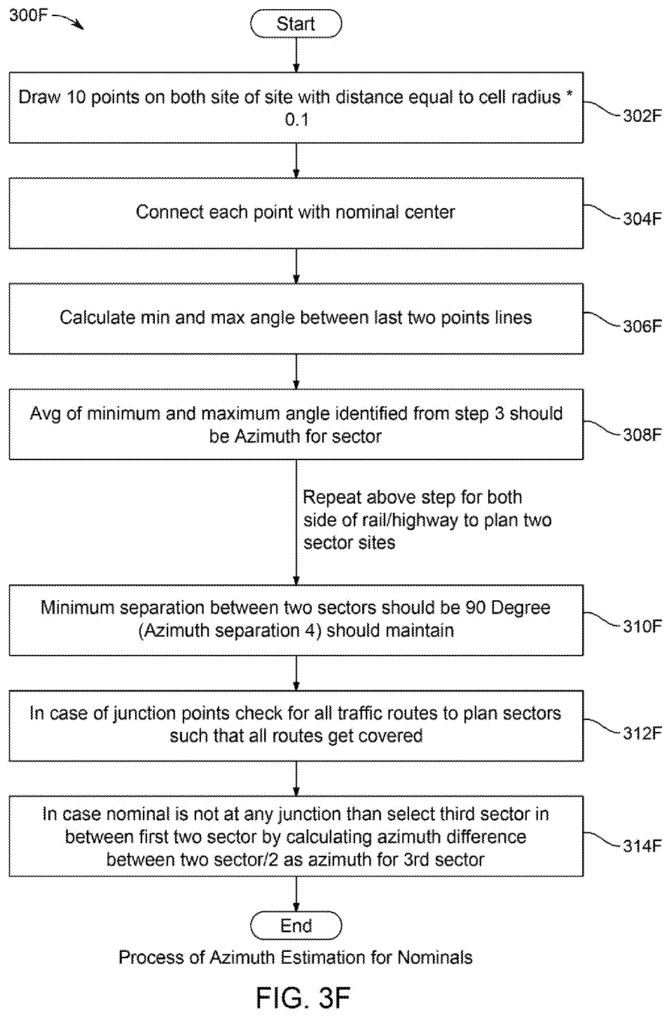

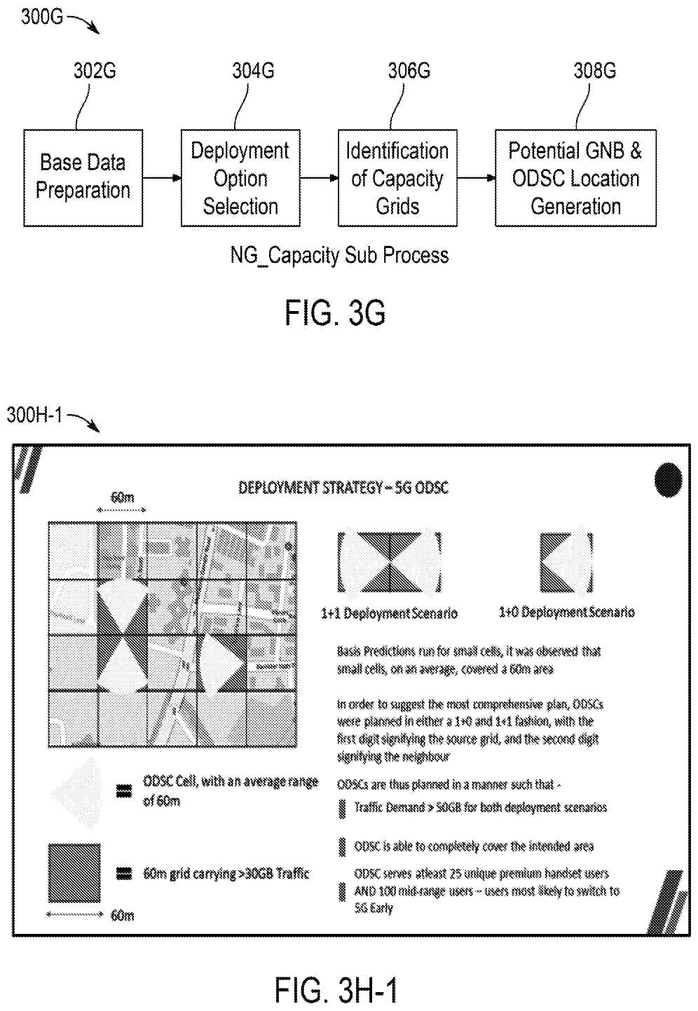

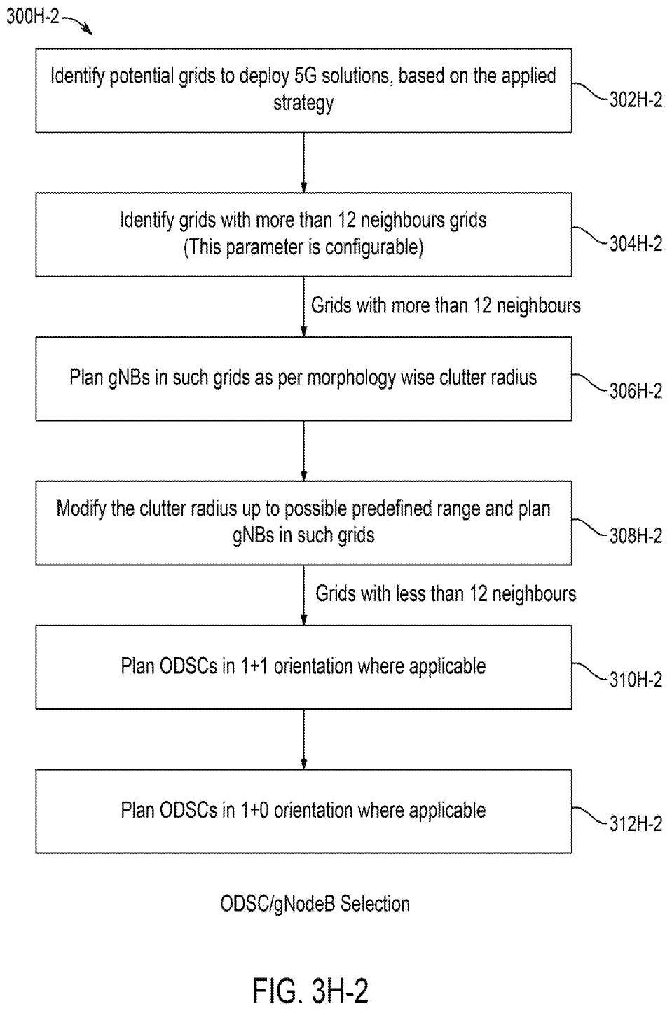

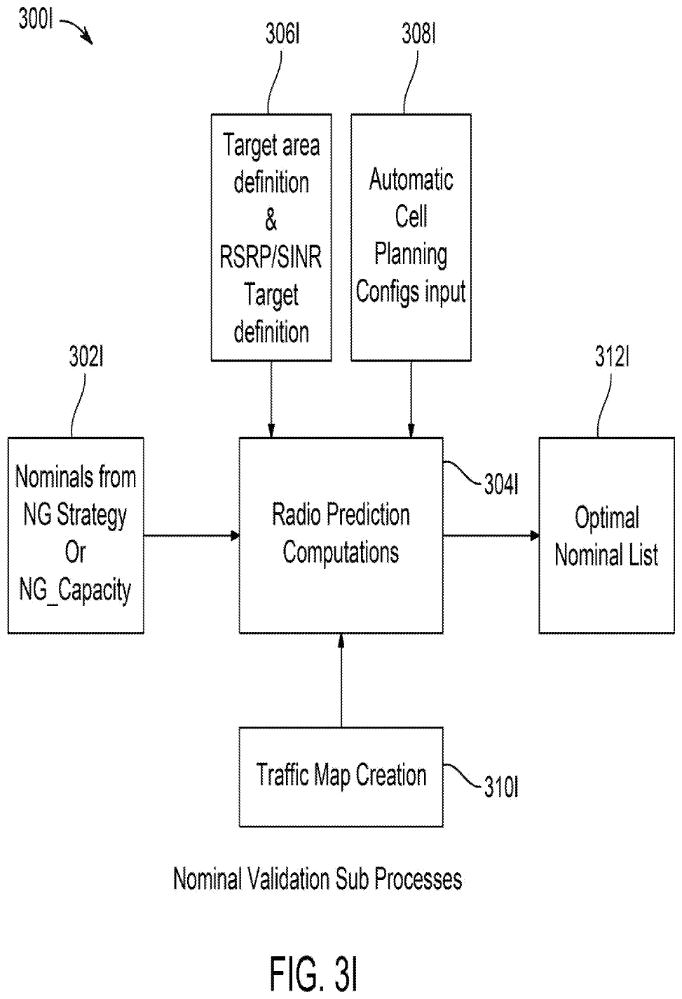

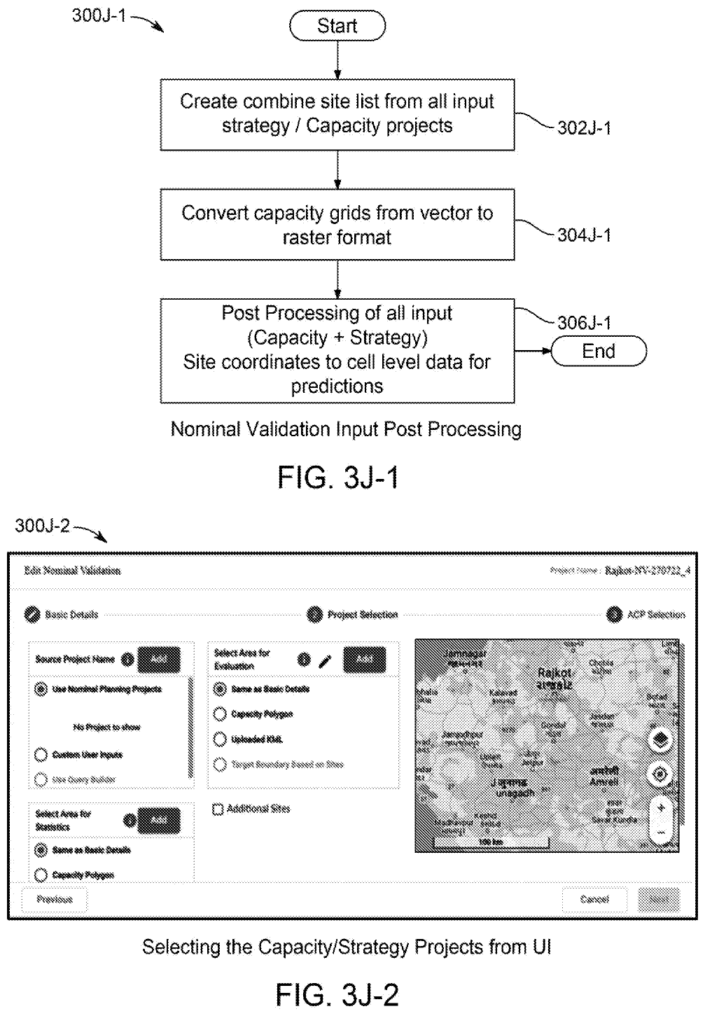

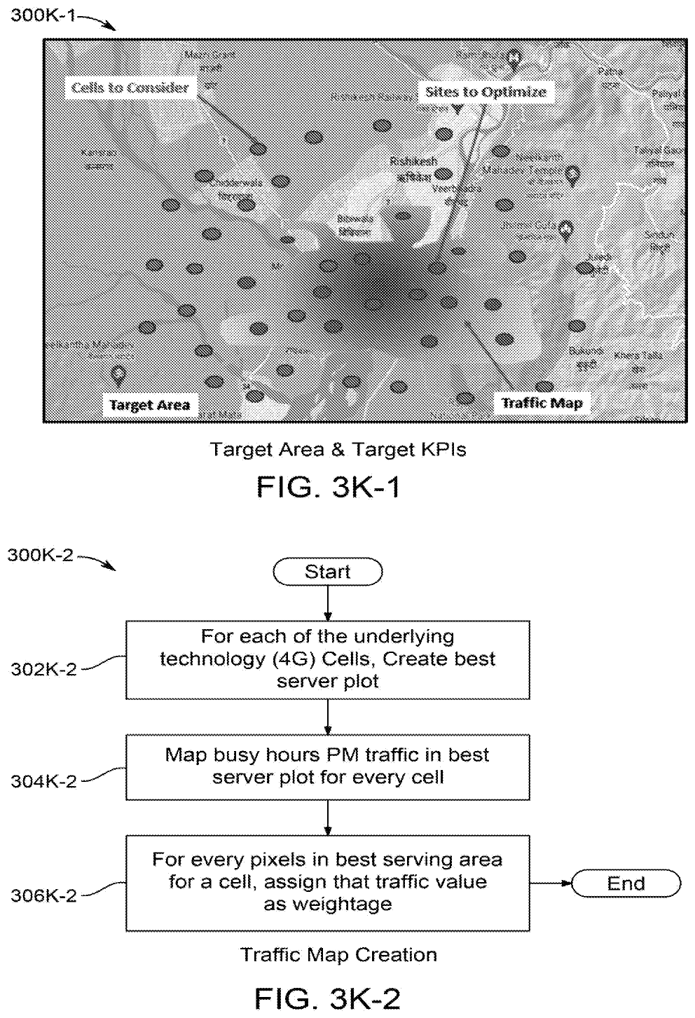

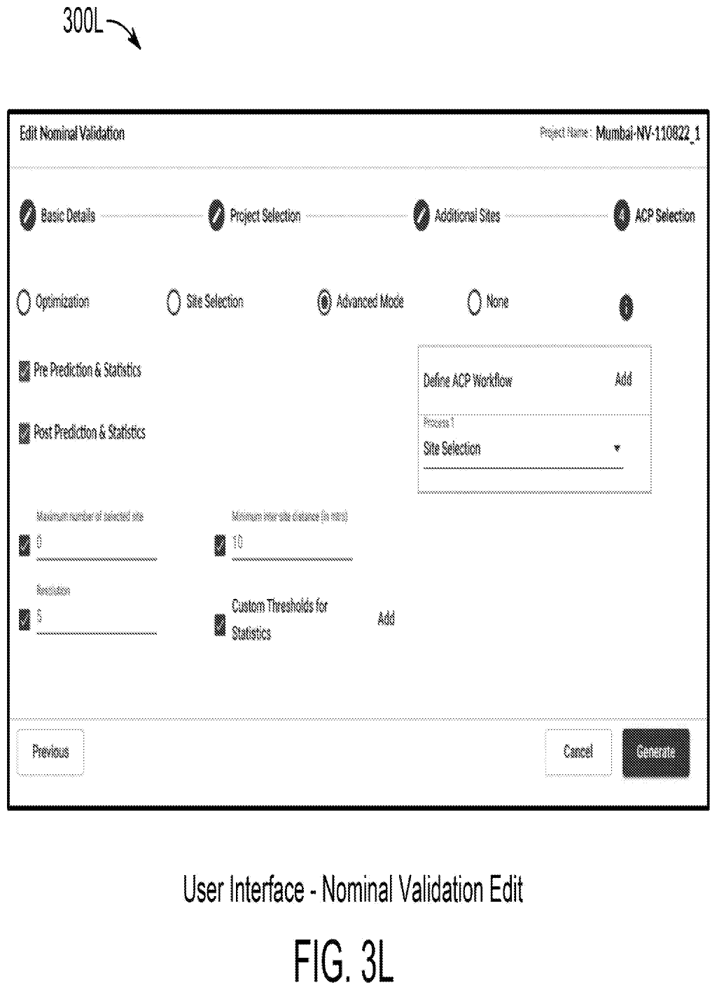

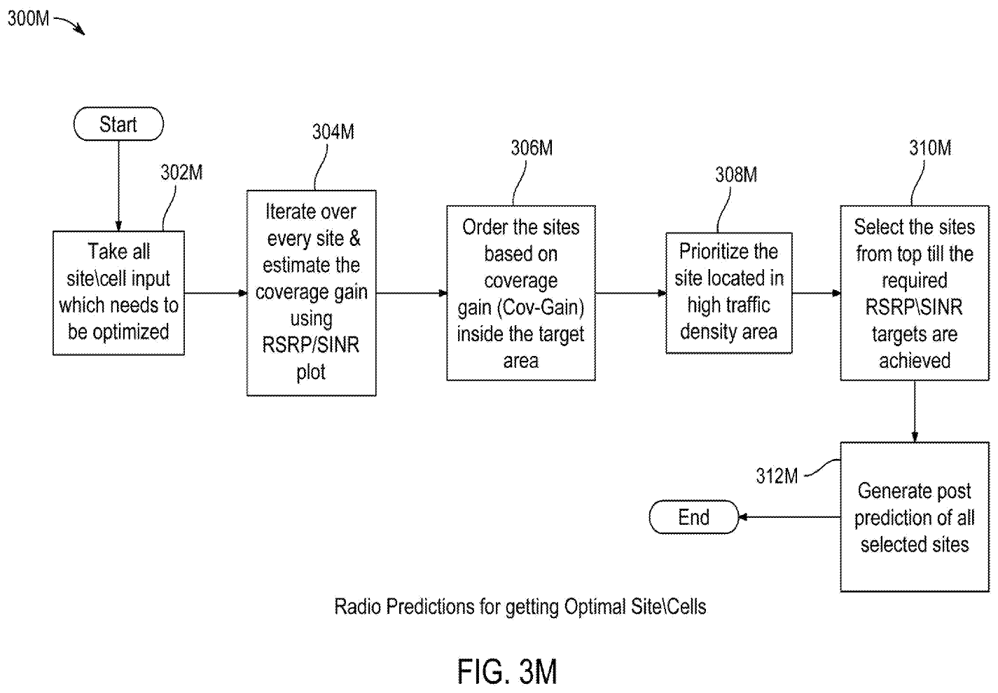

FIGS. 3A-3M illustrates an exemplary end to end (E2E) automated system and method for generating a network plan, in accordance with an embodiment of the present disclosure.

FIG. 3A illustrates an exemplary NG Capacity HL flow (300A), in accordance with an embodiment of the present disclosure.

At step 302A of location, identify the intended areas over which 5G coverage is to be provided. The overall strategy for 5G deployment for 5G coverage or 5G as a capacity solution.

At step 304A of position, after identifying the area, the location where a 5G site is to be deployed to serve the identified area is defined.

At step 306A of orientation, after identifying the ideal location to deploy the site, orientation and other parameters are decided. The orientation may include cell radius, cell range, grid count. The parameters may include azimuth, height, power.

FIG. 3B illustrates an exemplary NG Strategy HL flow (300B), in accordance with an embodiment of the present disclosure.

At step 302B, selection of geography is done.

At step 304B, defining cell radius for the selected geography.

At step 306B, the strategic data sources are selected.

At step 308B, strategic nominal generation algorithm is applied to the geography, cell radius, strategic data sources.

At step 310B, the strategic nominals are reviewed.

At step 312B, inputs to the nominal validation are provided.

FIG. 3C illustrates an exemplary Nominal validation (NV) module HL flow (300C), in accordance with an embodiment of the present disclosure.

At step 01, auto fetching all possible candidates based on coverage, capacity, strategic and business inputs.

At step 02, defining desired KPIs target and geographical area filters. The KPIs may include signal to interference noise ratio (SINR) and reference signal received power (RSRP).

At step 03, traffic density grids are used based on crowdsource data for pixel-by-pixel area weightage.

At step 04, customized automatic cell planning (ACP) workflow is defined.

At step 05, the ACP algorithm may recommend optimal sites and cell configurations.

At step 06, providing output (e.g. selected optimal sites and cell configuration) in the form of map visualization and downloadable reports.

FIG. 3D illustrates an exemplary E2E Automated System and Methodology for 5G Planning (300D), in accordance with an embodiment of the present disclosure.

At step 302D, receiving inputs from NG strategy module (302).

At step 304D, receiving inputs from NG capacity module (304).

At step 306D, performing nominal validation using automatic cell planning APIs. In nominal validation, target polygon is decided. KPI targets are determined, KPI are generated, and applying ACP mode.

At step 308D, 5G plan is executed, for example, by simulation, based on historical data and the like. The planned coverage is monitored.

FIG. 3E-1 illustrates NG_Strategy sub processes (300E-1), in accordance with an embodiment of the present disclosure.

At step 302E-1, output from all data sources is collected.

At step 304E-1, filtering sites based on strategic inputs.

At step 306E-1, filtering On-air/planned sites as nominal.

At step 308E-1, deriving best nominal location by finding correlation with fiber asset.

Further, strategic nominal candidates are provided based on the above steps.

FIG. 3E-2 illustrates triggering NG_Strategy job (300E-2), in accordance with an embodiment of the present disclosure.

At step 1, to define desire project geography, performing selection from administrative boundary and defining custom area.

At step 2, to define desired cell radius, linking budget template selection and customizing definition of cell radius.

At step 3, to select desired data sources, selection of data source, uploading non-standard data inputs, selecting desired query, selection of On-Air/planned site, selection of solution type.

In an aspect, Nominal Generation (NG) Algorithm 1,

Nominal Generation algorithm 1 may work on tabular information with different data types as input to the algorithm.

Based on data type of source information nominal will be generated through custom defined query.

Data filtration done through custom define query based on mathematics, string Boolean, etc, functions and operator on data sets for every nominal generated, a plurality of algorithms runs for getting the azimuths to server the target strategic area.

Following method 1 is used to estimate azimuth:
Create cone of 65 Degree (Cone BW) and start scanning entire area with 10 degree separation (total 36 cone will be created around each nominal)
Calculate number of buildings and landmark in each cone within cell radius distance
Identify cone with highest count of Building+Landmark points
Center angle of first cone will be azimuth of 1st Sector
Identify cone with 2nd highest counts of building+Landmark and center angle as azimuth for second sector
Check azimuth difference between 1st sector azimuth and center of second identified cone
If difference between two is more than 120 degree (Sector Separations1) and less than 180 Degree (Sector Separations2) than select second cone center as azimuth for 2nd sector, else take next cone with 10 degree change till criteria of sector separation 1 and 2 satisfy
Identify cone with 3rd highest count of building+Landmark and center angle as azimuth for 3rd sector
Check azimuth difference between 1st and 2nd sector azimuth and center of 3rd identified cone
If difference between 1st and 2nd sectors are more than 120 degree (Sector Separations1) than select second cone center as azimuth for 3rd sector, else take next cone with 10 degree change till criteria of sector separation 1 and 2 satisfy
If no cone has any building+Landmark points within cell radius distance than consider standard azimuth of 0 (Alpha), 120 (Beta) and 240 (Gamma) Degree.
If only 1st cone identified with building+Land mark points than consider center azimuth of cone as sector azimuth and plan 2nd sector with 120 Degree (Sector Separation 3) from 1st sector and 3rd sector with 120 Degree (Sector Separation 3) from 2nd sector.
If first 2 sector identified through building+Landmark points than plan 3rd sector with 120 Degree (Sector Separation 3) from 2nd sector.
Once all 3 sector azimuth has been identified, compare azimuth angle with 0 degree and arrange all 3 in highest to lowest order and assign sector 1,2 and 3 for output and further processing.

Following process is applied to estimate azimuths for the nominals:
Drawing 10 points on both the side of the site with distance equal to cell radius 0.1.
connecting each point with nominal center.
calculating min and max angle between last two points lines
average of minimum and maximum angle identified may be azimuth for sector
minimum separation between two sectors should be 90 degree (Azimuth separation 4) should maintain.
Checking for all traffic routes to plan sectors such that all routes get covered;
Calculating azimuth difference between two sector/2 as azimuth for 3rd sector when the nominal is not at any junction than select third sector in between first two sector.

### According to Nominal Generation Algorithm 2:

Nominal Generation algorithm work on boundary, area, polygon based input with clutter type and other data sets as inputs.
Nominal generating for uniform coverage across selected boundary/area/polygons
Identify underlying clutter type within town boundary.
Draw Hexagon for each clutter type based on cell radius.
Identify top north corner and check underlying clutter and place hexagon based on clutter type and priority of clutter and other network technical and not technical parameters as inputs.
Start placing surrounding hexagon such that each hexagon having common edge with near next hexagon
Select hexagon (Dense Urban, Urban, Sub Urban, Rural) based on center point location underlying clutter type

Nominal generation algorithm 3 may work on any vector data-based data sources such as railways and highways.

Following Nominal Generation steps:
Load data from respective data source within selected geography
Select top north point of respective data source
Select first point as first nominal based on point no 2
Use Rural/Highway cell radius from input section as an input
Use inter site distance=1.5 (Inter site coefficient) x Cell Radius
Start selection nominal based on inter site distance from each last selected nominal location
If last point (Which include junction where multiple rail/roads cross) of rail/road is within inter site distance and beyond Cell radius distance, select last location as a nominal point
If rail/road has junction where more than one routes get connected and last nominal is not at junction point than consider other route last nominal point as a reference point to plan nominal on route.
Repeat above steps till all rail/road routes get covered

Following method for Azimuth Planning:
Identify 10 (Azimuth Identification constant 1) points on rail/road at 0.1 (Azimuth Identification constant 2)×Cell Radius distance from nominal location in each direction (If Rail/Road end is within cell radius distance than use all possible identified locations)
Connect each identified point with nominal location and measure angle which makes with nominal location
Calculate minimum and maximum angle based on identified location
Average of Minimum and Maximum angle identified from step 4 should be Azimuth for sector
Repeat above step for both side of traffic routes/rail/highway/road to plan two sector sites
Minimum separation between two sectors should be 90 Degree (Azimuth Separation4) should maintain
In case of junction points check for all traffic routes to plan sectors such that all routes get covered
In case nominal is not at any junction than select third sector in between first two sector by calculating azimuth difference between two sector/2 as azimuth for 3rd sector (Calculate difference from both sector i.e difference between 1st sector—2nd Sector and 2nd Sector—1st Sector, consider highest separation among both sector difference for 3rd sector planning)
Once all sector azimuth has been identified, compare azimuth angle with 0 degree and arrange all in highest to lowest order and assign sector 1,2 and 3 for output and further processing.

### Following Nominal Generation Algorithm 4:

Nominal generation algorithm 4 works on vehicular traffic and congestion based on information.

### Following Nominal Generation Steps:

Load data from respective data source within selected geography.
Identify the Traffic colour (Brown and Red) for minimum 7 (Traffic Days)/7 days for minimum×(Traffic Hours)/24 hours. (X needs to be configurable).
Select top north point of respective traffic congested path
Select first point as first nominal based on point no 2 or check for any existing nominal planned within inert site distance to cover last congested routes, if nominal fount with inter site distance than pan site at end of inter site distance
Use Rural/Highway cell radius from input section as a input
Use inter site distance=1.5 (Inter site coefficient)×Cell Radius
Start selection nominal based on inter site distance from each last selected nominal location
If last point (Which include junction where multiple congested routes cross) of congested route is with inter site distance and beyond Cell radius distance, select last location as a nominal point
If congested route has junction where more than one routes get connected and last nominal is not at junction point than consider other route last nominal point as a reference point to plan nominal on route.
Repeat above steps till all congested routes get covered

Following Azimuth Planning steps:
Identify 10 (Azimuth Identification constant 1) points on rail/road at 0.1 (Azimuth Identification constant 2)×Cell Radius distance from nominal location in each direction (If Rail/Road end is within cell radius distance than use all possible identified locations)
Connect each identified point with nominal location and measure angle which makes with nominal location
Calculate minimum and maximum angle based on identified location
Average of Minimum and Maximum angle identified from step 4 should be Azimuth for sector
Repeat above step for both side of traffic routes to plan two sector sites
Minimum separation between two sectors should be 90 Degree (Azimuth Separation) should maintain
In case of junction points check for all traffic routes to plan sectors such that all routes get covered
In case nominal is not at any junction than select third sector in between first two sector by calculating azimuth difference between two sector/2 as azimuth for 3rd sector (Calculate difference from both sector i.e difference between 1st sector—2nd Sector and 2nd Sector—1st Sector, consider highest separation among both sector difference for 3rd sector planning)
Once all sector azimuth has been identified, compare azimuth angle with 0 degree and arrange all in highest to lowest order and assign sector 1,2 and 3 for output and further processing.

Following steps are performed for getting optimal sites/cells:
Taking all site/cell input which needs to be optimized.
Iterating over every site and estimate the coverage gain using RSRP/SINR plot.
Ordering the sites based on coverage gain (Cov-Gain) inside the target area.
Prioritizing the site located in high traffic density area.
Selecting the sites from the top till the required RSRP/SINR targets are achieved.
Generating post predication of all selected sites.

For Site Selections:
maintaining logs of each data source execution with execution status to use for landing page status as well as defining chaining of jobs.

Sequence of execution for all data sources:
All Data source except below can run parallel
Rollout obligations
Exclusion zone
Site Selection
Site list preparations
Input to Nominal Validations

For Macro Site selection process:
Considering all strategic site as final Nominal and draw buffer of X meter (Strategic site buffer).
Identifying all nominals within strategic buffer and discard all candidate with remarks as “Within x meter distance from Strategic site” and follow below steps for remaining candidates.
Identifying underlying clutter type for each nominal candidate
Drawing buffer of A Meters (buffer for existing site) from each Nominals
If any existing On-Air/Planned site found within buffer, consider existing On-Air/Planned site as a nominal else process for step 7 (To be consider as per inputs, if user select do not consider On-Air sites in nominal planning than exclude these steps from site selections)
Getting On-Air Site/Planned details such as SAP ID, Location, Azimuth, Height, Media information's and update remarks as “On-Air Sites within X meter for nominal which is discarded.
Drawing buffer around each nominal with radius of X Meters cell radius
Checking for any other nominal with each buffer
If any other nominal is present use plan B else use Plan A

Plan A:
Measuring distance from nearby fiber route point, fiber structure, equipment and on-air 4g Sites
Getting fiber route type, Structure/Equipment name, 4G sites SAP ID and distance from each for report

Plan B:
Measuring distance between each nominal within buffer
If distance between nominal is more than 0.8×Cell radius select both nominalsIf distance is less than 0.8×Cell Radius follow below steps:
Measuring distance from nearby structure/equipment
If distance from nearby structure/equipment is less than 1000 meter than follow Path A else follow Path B

Path A:
Checking for priority of nominal sites
If high priority among all candidates having lowest distance from structure/equipment, select that nominal as a final one and ignore other nominals
If high priority sites having more distance from structure/equipment than check high priority nominal distance from fiber route nearby points. In case distance form high priority nominal from fiber route is less than distance of low priority site from structure/equipment than select high priority candidate else follow below step.
If High priority site distance from structure/equipment is 10% more than distance from lower priority site than select high priority nominal else follow below step
Putting remarks for all discarded nominal as “High Priority candidate Selected”
Selecting low priority nominal which has lowest distance from structure/Equipment (Update remarks as “Low Priority candidate on fiber location” for all discarded nominals). If selected nominal distance is within 20 Meters (Fiberized Distance) than consider Structure/Equipment location as a candidate and update remarks as “Structure/Equipment available within X Meters as not selection remarks for excluding nominals

Path B:
Checking for priority of each nominal sites and select sites with highest priority (Remarks for discarding candidates-Other high priority nominal considered”)
Measuring distance from nearby fiber route point, fiber structure, equipment and on-air 4g Sites
Getting fiber route type, Structure/Equipment name, 4G sites SAP ID and distance from each for report No sites to be plan in exclusion zone area and if any nominal falls within exclusion zone than mark “Exclusion Zone” as remarks for such nominals
All discarded sites need to mark with reasons for not considering in final plan

For Indoor Small Cell selection process:
Indoor Small Cell selection process to be trigger post Macro site selection completions
Considering all strategic site with Indoor small cells as a site type with number of small cells
If any existing Indoor On-Air/Planned site found with building ID same as valid nominal building ID consider existing On-Air/Planned site as a nominal else process next step (To be consider as per inputs, if user select do not consider On-Air sites/Planned in nominal planning than exclude these steps from site selections)
Getting On-Air/Planned Site details such as SAP ID, Location, Azimuth, Height, Media, Number of Cells information's
Processing for Building and Demand Point data sources
User Building data source for indoor small cell planning
Building nominal which is valid and not considered in Macro site planning to be consider for Indoor small cell planning
Calculating distance of all valid nominal from Near By Macro Nominal candidates
If Distance of valid building nominals is more than X Meters (Small Cell Distance) than consider such building for Indoor Small Cell Nominals
Calculating area of building polygon in Sq. Meter
Number of Indoor Small Cell per Floor=Roundup (Building Polygon Area/Small Cell Coverage Area, 0)
Total Number of Indoor Small Cell=Number of Indoor Small Cell X Number of Floor in buildingProcessing for Other Data Sources:
Nominal which is valid and not considered in Macro site planning to be consider for Indoor small cell planning
Calculate distance of all valid nominal from Near By Macro Nominal candidates
If Distance of valid nominals is more than X Meters (Small Cell Distance) than consider such Nominal for Indoor Small Cell Nominals
Number of Indoor Small Cells=1 Small Cell per locations

Outdoor Small Cell selection process:
Outdoor Small Cell selection process to be trigger post Macro site selection completions
Consider all strategic site with Outdoor small cells as a site type with number of small cells, Nominal which is valid and not considered in Macro site planning to be consider for Outdoor small cell planning
Calculate distance of all valid nominal from Near By Macro and Outdoor small cell Nominal candidates
If Distance of valid nominals is more than X Meters (Outdoor Small Cell Distance) than consider such Nominal for Outdoor Small Cell Nominals
Number of Indoor Small Cells=Number of Sector identified for respective data source nominals
If any existing Outdoor On-Air/Planned site found within X meter Buffer (existing Outdoor buffer), consider existing On-Air/Planned site as a nominal (To be consider as per inputs, if user select do not consider On-Air/Planned sites in nominal planning than exclude this steps from site selections) Getting On-Air Site/Planned details such as SAP ID, Location, Azimuth, Height, Media and Number of Outdoor Cells, Number of Sectors information's.

FIG. 3E-3 illustrates an output from NG_Strategy (300E-3), in accordance with an embodiment of the present disclosure. The output includes summary and output map visualizations.

FIG. 3F illustrates process of azimuth estimation for nominals (300F), in accordance with an embodiment of the present disclosure.

At step 302F, perform drawing 10 points on both sides of site with distance equal to cell radius*0.1.

At step 304F, perform connecting each point with nominal center.

At step 306F, perform calculating min and max angle between last two points lines.

At step 308F, perform average of minimum and maximum angle identified from step 3 may be azimuth for sector.

At step 310F, minimum separation between two sectors may be 90 degree (azimuth separation 4) may maintain.

At step 312F, in case of junction points check for all traffic routes to plan sectors such that all routes get covered.

At step 314F, in case nominal is not at any junction than select third sector in between first two sector by calculating two sector/2 as azimuth for 3rd sector.

FIG. 3G illustrates NG capacity subprocess (300G), in accordance with an embodiment of the present disclosure.

At step 302G, perform preparing base data for the process.

At step 304G, perform selecting deployment option.

At step 306G, perform identifying capacity grids.

At step 308G, perform generating potential gNB and outdoor small cell (ODSC) location.

FIG. 3H-1 illustrates deployment strategy—5G ODSC (300H-1), in accordance with an embodiment of the present disclosure. 1+1 deployment scenario and 1+0 deployment scenario are shown.

Basic predications for small cells, ODSCs may plan in either 1+0 and 1+1 fashion, first digit may signify the source grid and second digit signify neighbor.

To determine what type of solution is to be deployed at a given location, the following parameters are used.
1) No. of neighbour grids—The no. of neighbour grids settings determines at what density of potential 5G grids is it viable to deploy a gNodeB. The recommended setting is 12 for GNodeB Cells but value is configurable between 8 to 24. Single ODSC Cells have a range of ˜60 m, therefore there are only two orientations that they can be planned; 1+0 and 1+1.
2) Number of Premium, Mid-range and Budget Handset Users—User Density, particularly, the density of customers by device type, is also an important factor to consider while deciding where to place a gNodeB or an ODSC. Higher Priced Phones correlates with higher income, and higher income individuals are more likely to pay extra for 5G, all other factors being equal. Planners can set thresholds for the minimum number of users required to be present in the range of a gNodeB or ODSC.
3) Minimum Traffic to be catered—Based on the existing 4G consumption of an area, planners can define the minimum traffic a given solution should carry. As a best practice, the current threshold for gNodeBs are set at 400 GB, and 60 GB for ODSCs.
4) Scaling Factor—Owing to higher bandwidths and faster speeds on 5G, consumption is bound to increase for data-heavy applications like video and gaming. The scaling factor lets the engineer estimate the increase in demand, as a multiple of the existing demand.
5) 5) If the scaling factor is set at 2, the solution threshold requirements are cut in half. gNodeBs will be planned based on 200 GB 4G traffic instead of say, 400 GB with scaling=1. This indirectly means the traffic on 5G gNodeB is expected to be 2 times the current 4G traffic.

ODSC are planned in manner such that:
Traffic demand >50 GB for both deployment scenarios
ODSC is able to completely cover the intended area.
ODSC serves at least 25 unique premium handset users and 100 mid-range users-users most likely to switch to 5G early.

FIG. 3H-2 illustrates ODSC/gNodeB selection (300H-2), in accordance with an embodiment of the present disclosure.

At step 302H-2, perform identifying potential grids to deploy 5G solutions based on the applied strategy.

At step 304H-2, identify grids with more than 12 neighbour grids.

At step 306H-2, when grids more than 12 neighbour grids, planning gNBs in grids as per morphology wise clutter radius.

At step 308H-2, perform modifying the clutter radius up to possible predefined range and planning gNBs in such grids.

At step 310H-2, when grids less than 12 neighbours, planning ODSCs in 1+1 orientation where applicable.

At step 312H-2, perform planning ODSCs in 1+0 orientation where applicable.

FIG. 3I illustrates nominal validation sub-processes (300I), in accordance with an embodiment of the present disclosure.

In the nominal validation sub-processes, radio predication computations (step 304I) may receive inputs from NG strategy or NG capacity (step 302I), target area definition and RSRP/SINR definition (step 306I), automatic cell planning configurations (step 308I), traffic map creation (step 310I) The radio predication computations may generate list of optimal

nominals at step 312I. The nominals may include site locations and cell configurations.

FIG. 3J-1 illustrates nominal validation input post-processing (300J-1), in accordance with an embodiment of the present disclosure.

At step 302J-1, creating combine site list from all input strategy/capacity projects is performed.

At step 304J-1, converting capacity grids from vector to raster format is performed.

At step 306J-1, post processing of all input (capacity+strategy) site coordinates to cell level data for predications is performed.

FIG. 3J-2 illustrates selecting the Capacity/Strategy Projects from UI (300J-2), in accordance with an embodiment of the present disclosure.

Cell Creation on basis ‘Solution Type’ only

| Solution Type | Template to be used |
|---|---|
| Solutiontype = 1 + 0 | Use site template |
| | “template_ODSC1” |
| Solutiontype = 1 + 1 | User site template |
| | “template_ODSC2” |
| Solutiontype = GNB | Use site template “template_GNB” |

Cell Creation on basis both ‘Solution Type’ and ‘Site Category’

| | Solution Type | | |
|---|---|---|---|
| | ODSC1 | ODSC2 | |
| Site category | (1 + 0) | (1 + 1) | GNB |
| NewNominal | 9 m, (0 | 9 m, (0 | 25 m, (0, 120, 240 deg) |
| | deg) | and 180 | |
| | | deg) | |
| 4G_Macro | 15 m, (0 | 15 m, (0 | Height same as 4G macro, |
| | deg) | and 180 | 0, 120, 240 deg |
| | | deg) | |
| FiberizedRoute | 9 m, (0 | 9 m, (0 | 25 m, (0, 120, 240 deg) |
| | deg) | and 180 | |
| | | deg) | |
| FiberizedBuilding | | | 25 m, (0, 120, 240 deg) |
| 4G_SmallCell | 9 m, (0 | 9 m, (0 | 25 m, (0, 120, 240 deg) |
| | deg) | and 180 | |
| | | deg) | |

After converting site level data to cell level data wherever Sitecategory=_4G_Macro or _4G_smallcell, for all those records update height.

Set height/azimuth, tilt (min [10, total tilt]) equal to the value as present in 4G network.

FIG. 3K-1 illustrates Target Area and Target KPI (300K-1), in accordance with an embodiment of the present disclosure.

In order to get optimal site and cell configuration, another inputs needs to be passed for defining Target Area and KPI Targets

Target Area—Once this area is given as input, then component 3 will aim for improving KPI, within this defined area only. Site and cell changes

Target KPIs-RSRP and SINR KPI targets needs to be defined. Component 3 does optimal site\cell selection to improve KPI within the Target areas. If there is existing ONAIR sites, then that site is also considered during site selection.

FIG. 3K-2 illustrates traffic map creation (300K-2), in accordance with an embodiment of the present disclosure.

At step 302K-2, best server plot for each of the underlying technology (4G) cells is created.

At step 304K-2, busy hour PM traffic in best server plot for every cell is mapped.

At step 306K-2, traffic value as weightage for every pixel in best serving area for a cell is assigned.

FIG. 3L illustrates user interface (UI)-nominal validation edits (300L), in accordance with an embodiment of the present disclosure.

FIG. 3M illustrates radio predictions for getting optimal site\cells (300M), in accordance with an embodiment of the present disclosure.

At step 302M, all site/cell input which needs to be optimized is taken.

At step 304M, every site and estimating a coverage gain using RSRP/SINR plot is iterated.

At step 306M, sites based on coverage gain inside the target area is ordered.

At step 308M, site located in high traffic density area is prioritized.

At step 310M, selecting the sites from top till the required RSRP/SINR targets are achieved.

At step 312M, post predication of all selected sites is generated.

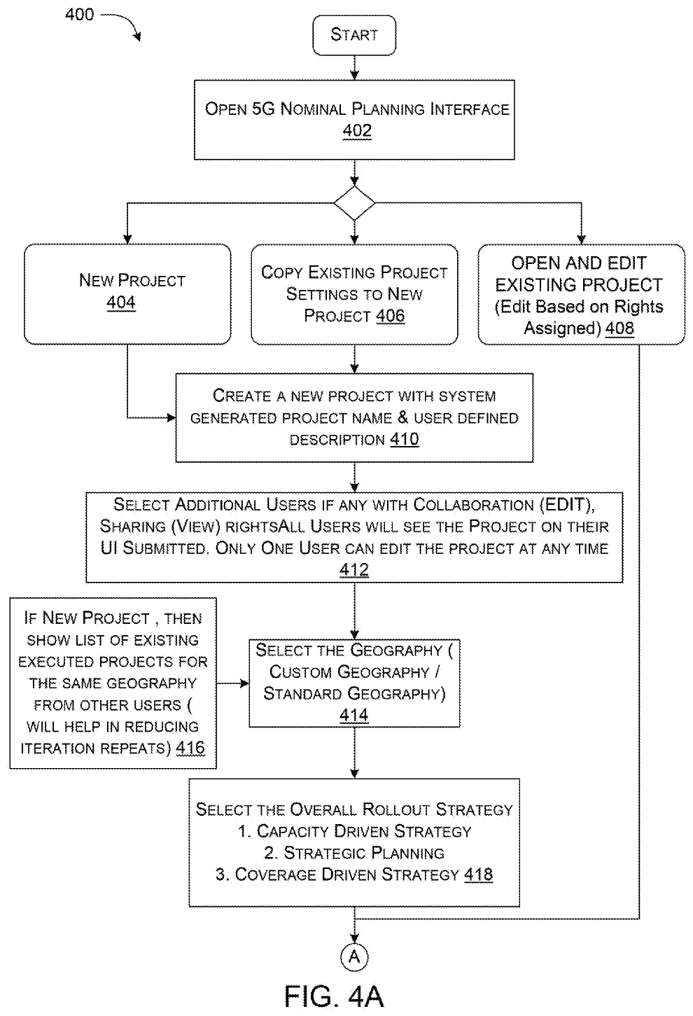

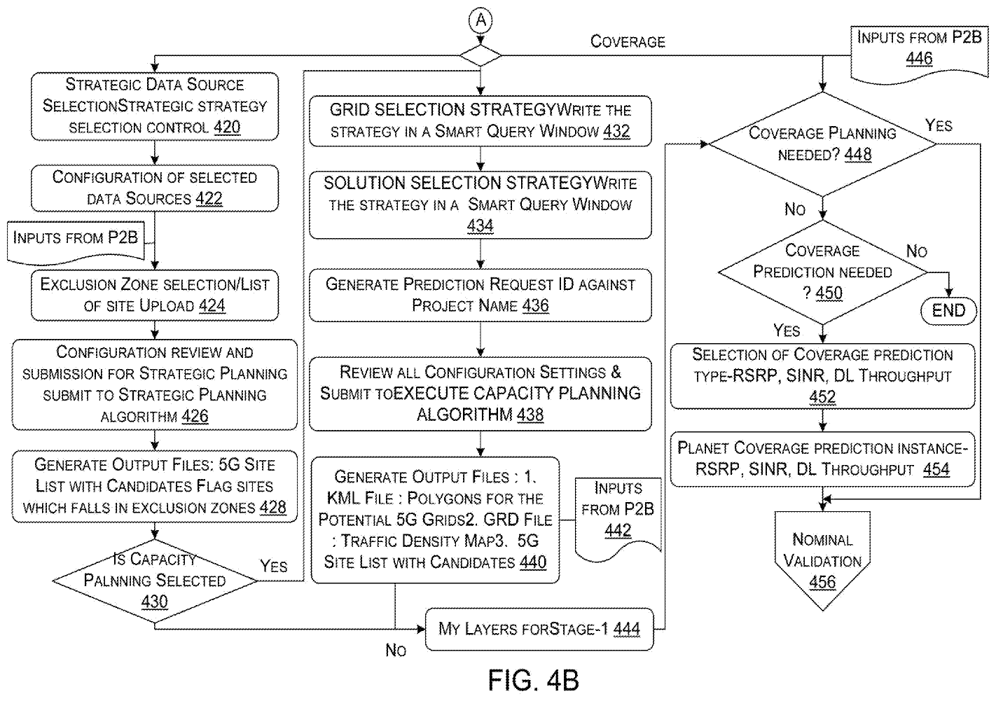

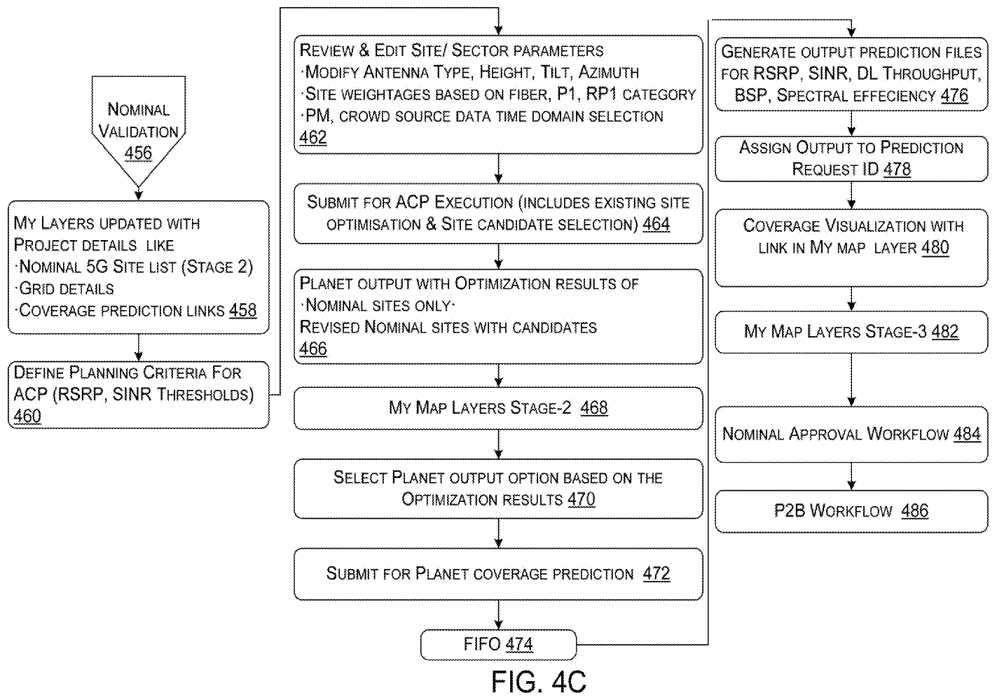

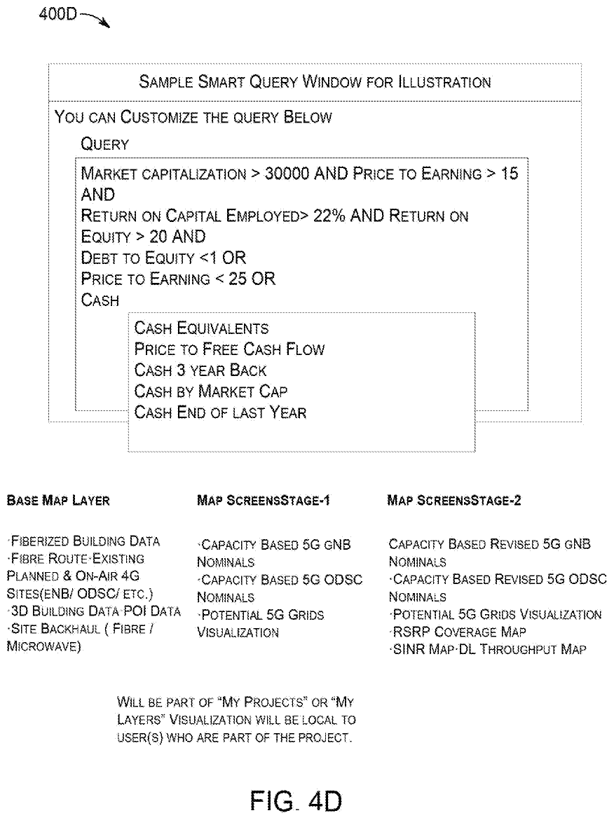

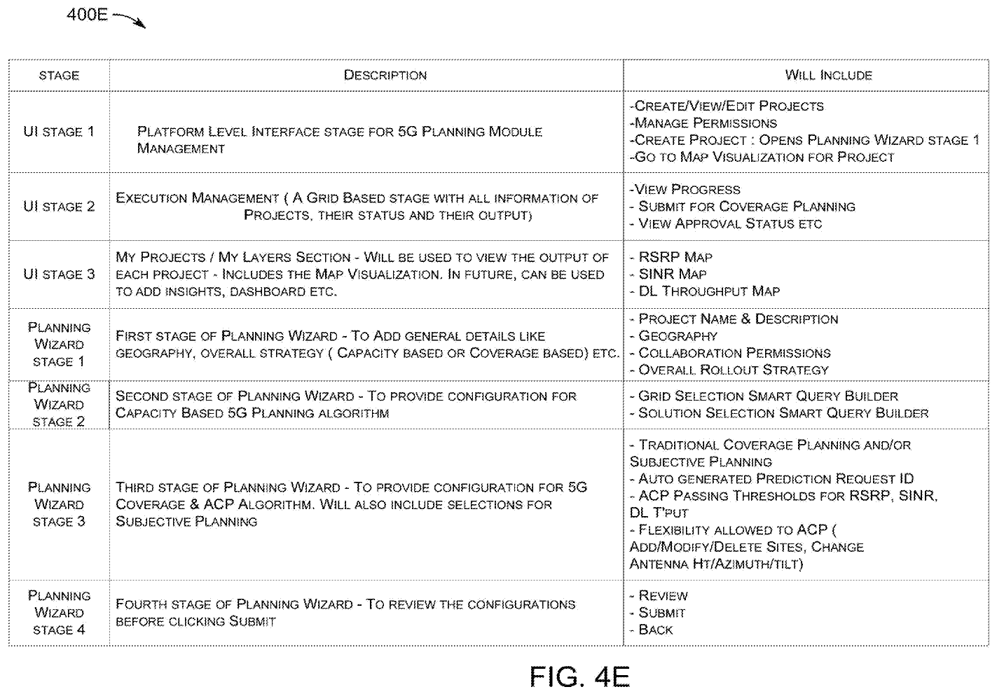

FIGS. 4A-4E illustrate exemplary end to end (E2E) 5G nominal planning flow (400) of the system (110), in accordance with embodiments of the present disclosure.

As illustrated in FIGS. 4A-4E, the system (110) with an E2E 5G nominal planning may include a user interface (UI) and may utilize the following steps.

At Step 402: A 5G nominal planning UI may be opened in the planning interface of the system (110).

The system (110) may present three different options: At 404, UI with a new project may be presented on the interface, at 406, a UI that may copy existing project settings to the new project may be presented on the interface, and at 408, a UI that may open and edit an existing project may be presented on the interface. The existing projects can be edited based on the assigned rights.

At Step 410: The system (110) may present the option “Create a new project with system generated project name and user defined description” to the user on the interface.

At Step 412: The system (110) may pertain to user and permission management. The option “Select additional users if any with collaboration (EDIT), sharing (View) rights” may be presented to the user on the interface. All Users will see the project on their UI submitted. Only one user may edit the project at any time.

At Step 414: The system (110) may present the following option “Select the Geography (Custom Geography/Standard Geography)”. Further, at 416 in case of a new project then a list of existing executed projects for the same geography from other users will be shown to the user on the interface. This will help in reducing iteration repeats.

At Step 418: The system (110) may provide the following option “Select the Overall Rollout Strategy1. Capacity Driven Strategy 2. Strategic Planning 3. Coverage Driven Strategy”.

At Step 420: The system (110) may present strategic planning and the option “Strategic Data Source Selection Strategic strategy selection control”.

At Step 422: The system (110) may present the option “Configuration of selected data Sources”.

At Step 424: The system (110) may receive inputs from a P2B and present the option “Exclusion Zone selection/List of site Upload”.

At Step 426: The system (110) may present the option “Configuration review and submission for Strategic Planning submit to Strategic Planning algorithm”.

At Step 428: The system (110) may present the option “Generate output files 5G list with candidates, flag sites which fall in exclusion zones”.

At Step 430: The system (110) may determine if capacity plan is selected.

At Step 432: Based on a generated positive determination at step 430, the system (110) may select a capacity driven strategy and present the option “GRID SELECTION STRATEGY where the strategy can be written in a Smart Query Window”.

At Step 434: The system (110) may present the option “SOLUTION SELECTION STRATEGY where the strategy in a Smart Query Window”.

At Step 436: The system (110) may present the option “Generate Prediction Request ID against Project Name”.

At Step 438: The system (110) may present the option “Review all Configuration Settings and Submit to EXECUTE CAPACITY PLANNING ALGORITHM”.

At Step 440: The system (110) may present the option “Generate output files. 1. Keyhole Markup Language (KML) file: Polygons for the potential 5G grids. 2. Graphic Gallery (GRG) file: Traffic density map”. 3. 5G site list with candidates. The output files are generated by taking inputs from the P2B (at step 442).

At Step 444: Based on generated negative determination at step 430, and after the output files are generated, the system (110) may provide the option “My layers for Stage-1”.

At Step 446: The system (110) may utilize inputs from P2B and perform coverage planning at step 448, where the UI may determine if coverage planning is needed or not.

At Step 456: Based on a generated positive determination at step 448, the system (110) may provide nominal validation.

At Step 450: Based on a generated negative determination at step 448, the system (110) may further determine if coverage prediction is needed. Based on a generated negative determination at step 450, the system (110) may end the session.

At Step 452: Based on a generated positive determination at step 450, the system (110) may provide the option “Selection of Coverage prediction type-RSRP, SINR, DL Throughput”. In an aspect, the RSRP stands for reference signal received power. The RSRP is defined as linear average over the power contributions (in Watts) of the resource elements which carry synchronization signals. The SINR stands for signal-to-noise and interference ratio. The SINR is defined as the linear average over the power contribution (in Watts) of the resource elements carrying synchronisation signals divided by the linear average of the noise and interference power contribution (in Watts) over the resource elements carrying synchronisation signals within the same frequency bandwidth.

At Step 454: The system (110) may present the option “Planet Coverage Prediction Instance-RSRP, SINR, DL Throughput” and further provide nominal validation.

At Step 458: Once nominal validation is generated, the system (110) may provide the options “My Layers updated with Project details like Nominal 5G Site list (Stage 2)· Grid details · Coverage prediction links”.

At Step 460: The system (110) may provide the option “Define Planning Criteria for ACP (RSRP, SINR Thresholds)”.

At Step 462: The system (110) may provide the options “Modify Antenna Type, Height, Tilt, Azimuth Site weightages based on fiber, P1, RP1 category PM, crowd source data time domain selection” under the review & edit site/sector parameters. The crowdsourced RF data may include data collected from the plurality of user terminals or dedicated collection devices in the network. A plurality of mobile operators or research groups may provide applications to collect data from the plurality of user terminals or dedicated collection devices.

At Step 464: The system (110) may provide the options “Submit for ACP Execution” (that further includes existing site optimisation and Site candidate selection).

At Step 466: The system (110) may provide the options “Planet output with optimization results of nominal sites only and revised nominal sites with candidates.

At Step 468: The system (110) may provide the option “My Map Layers Stage-2”.

At Step 470: The system (110) may provide the option “select planet output option based on the optimization results”.

At Step 472: The system (110) may provide the option “Submit for Planet coverage prediction”.

At Step 476: The system (110) may provide the option “Generate output prediction files for RSRP, SINR, DL Throughput, Spectral efficiency” using the First in first out (FIFO) mechanism at step 474.

At Step 478: The system (110) may provide the option “Assign Output to Prediction Request ID”.

At Step 480: The system (110) may provide the option “Coverage Visualization with link in my map layer”.

At Step 482: The system (110) may provide the option “My Map Layers Stage-3”.

At Step 484: The system (110) may provide the option “Nominal Approval Workflow”.

At Step 486: The system (110) may provide the option “P2B workflow”.

Henceforth, the present disclosure advances the network planning and deployment as a single solution that may include, but not limited to, nominal generations, validations, site selections, azimuth planning, estimations, and deploying an end-to-end network in the planned area.

As illustrated FIG. 4D represents a sample smart query window (400D) for illustration. A query can be displayed and customized in the window. Further the base map layer includes fiberized building data, fibre route, existing planned & On-Air 4G sites (eNodeB, (outdoor small cell (ODSC) etc.), 3D building data, POI data, site backhaul (fiber/microwave). The map screens stage-1 includes capacity based 5G gNb nominals, capacity based 5G ODSC nominals, potential 5G grids visualization. The map screens stage-2 includes capacity based revised 5G gNb nominals, capacity based 5G ODSC nominals, potential 5G grids visualization, RSRP coverage map, SINR map-DL throughput map. The smart query window will be a part of “My Projects” or “My Layers” and visualization will be local to user(s) who are part of the project. As illustrated FIG. 4E represents the plurality of stages and their description (400E). In an aspect, UI stage 1 describes platform level interface stage for 5G planning module management. The UI stage 1 includes create/view edit projects, manage permissions, create project that opens planning wizard stage 1 and go to map visualization for project.

The UI stage 2 describes execution management that is a grid-based stage with all information of projects, their status and their output. The UI stage 2 includes view progress, submit for coverage planning, view approval status etc.

The UI stage 3 describes my projects/my layer section that will be used to view the output of each project such as map visualization. In future, it can be used to add insights, dashboards etc. The UI stage 3 includes Reference Signal Received Power (RSRP) map, signal-to-interference-plus-noise ratio (SINR) map, and downlink (DL) throughput map.

The planning wizard stage 1 is a first stage of planning wizard that is used to add general details like geography, overall strategy (capacity based or coverage based etc.). The planning wizard stage 1 includes project name & description, geography, collaboration permission and overall rollout strategy.

The planning wizard stage 2 is a second stage of planning wizard to provide configuration for capacity based 5G planning algorithm. The planning wizard stage 2 describes grid selection smart query builder and solution selection smart query builder.

The planning wizard stage 3 is a third stage of planning wizard that is used to provide configuration for 5G coverage & Automatic cell planning (ACP) algorithm. This stage will also include selections for selective planning. The planning wizard stage 3 includes traditional coverage planning and/or subjective planning, auto generated prediction request ID, Automatic cell planning (ACP) passing thresholds for Reference Signal Received Power (RSRP), signal-to-interference-plus-noise ratio (SINR), downlink (DL) throughput, flexibility allowed to ACP (add/modify/delete sites, change antenna height/azimuth/tilt).

The planning wizard stage 4 is a fourth stage of planning wizard that is used to review the configurations before clicking submit. The planning wizard stage 4 includes review, submit and back choices.

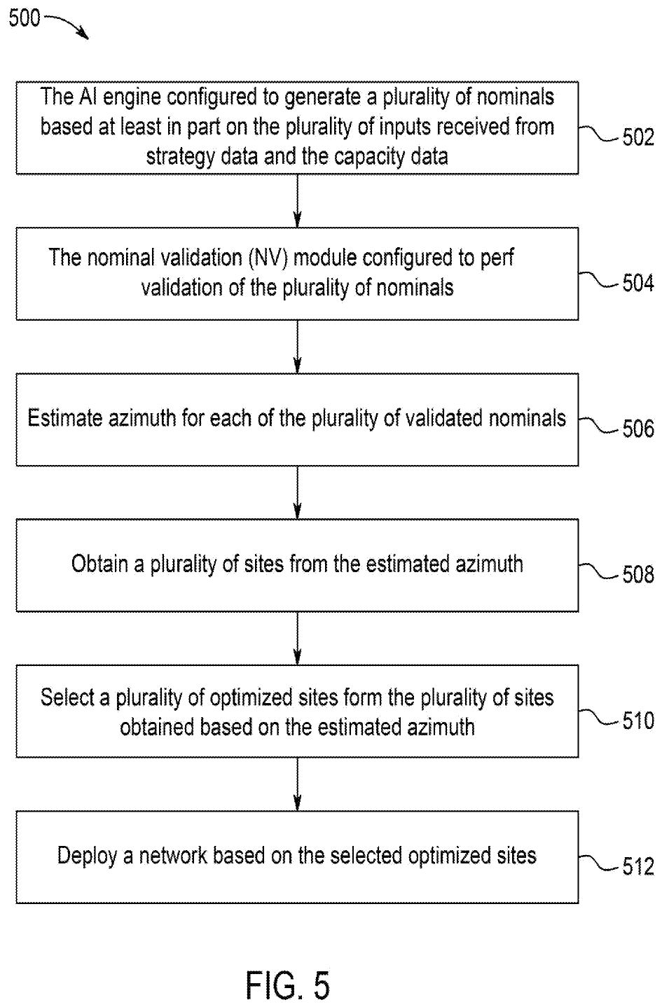

FIG. 5 illustrates an exemplary process (500) for the network deployment, in accordance with an embodiment of the present disclosure.

As illustrated in FIG. 5, the following steps may be included for the network deployment based on the plurality of sites.

At Step 502: AI engine generates a plurality of nominals based at least in part on the plurality of inputs received from strategy data and the capacity data.

At Step 504: the nominal validation (NV) module performs validation of the plurality of nominals.

At Step 506: estimation of azimuth for each of the one or more validated nominals is performed.

At step 508: a plurality of sites from the estimated azimuth are obtained.

At Step 510: a plurality of optimized sites forms the plurality of sites obtained based on the estimated azimuth is selected.

At Step 512: The system (110) may deploy the network based on selected one or more optimized sites.

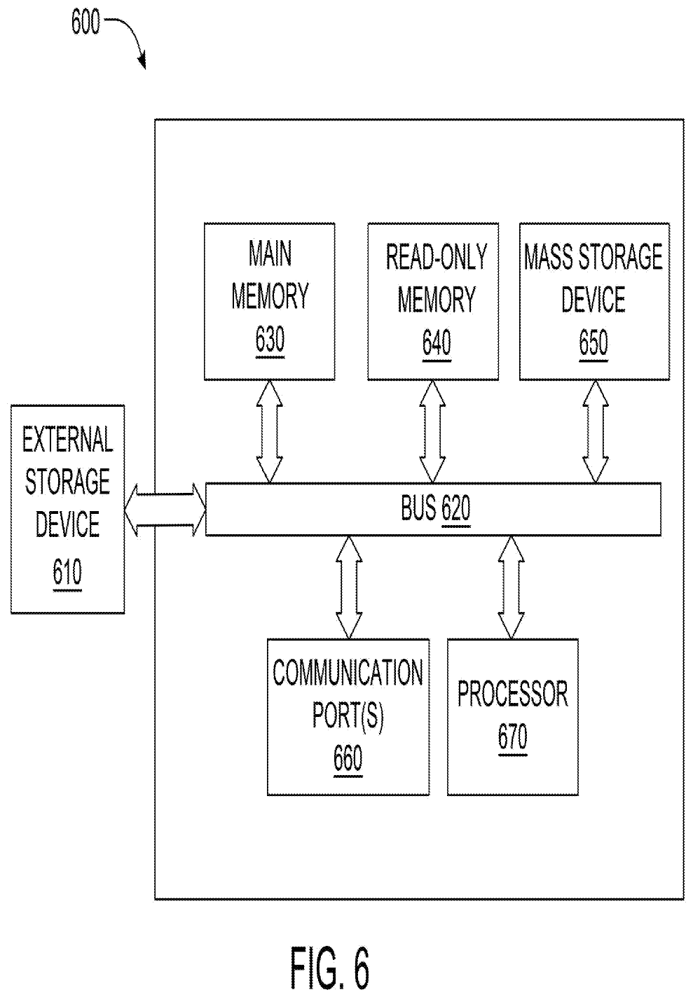

FIG. 6 illustrates an exemplary computer system (600) in which or with which the proposed system (110) may be implemented, in accordance with an embodiment of the present disclosure. As shown in FIG. 6 the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects. In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (2900) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that utilizes a cloud native architecture which eliminates a traditional desktop-based approach with new innovative and automated planning using radio application programming interfaces (APIs) hosted on a centralized infrastructure.

The present disclosure provides a system and a method that generates an optimal planning output and multiple network insights in a time bound manner for making quick business decisions regarding network planning.

The present disclosure provides a system and a method that provides an end to end (E2E) solution that employs unique sets of web applications for automated 5G planning and deployment.

The present disclosure provides a system and a method that provides cellular planning which touches all requirements from a network capacity/strategic point of view and further generates site locations/cell configurations that auto fine-tuned using a radio predictive engine.

The present disclosure provides a system and a method that automates an entire process of ingesting huge crowdsource data, geospatial data, and performs predictions and analysis for generating optimal sites associated with network planning.

We claim:

1. A method for performing network planning and deployment, the method comprising:
generating, by an artificial intelligence (AI) engine, a plurality of nominals based at least in part on the plurality of inputs from strategy data and capacity data, wherein the plurality of nominals includes a plurality of site locations and their corresponding site configurations;
performing, by a nomination validation module, validation of the plurality of nominals;
estimating azimuth for each of the plurality of validated nominals;
obtaining a plurality of sites from the estimated azimuth;
selecting a plurality of optimized sites from the plurality of sites obtained based on the estimated azimuth; and
deploying a network based on the selected optimized sites, wherein the selected optimized sites have optimal values of reference signal received power (RSRP) and a signal to interference and noise ratio (SINR), an optimal count of sites with optimized tilt and azimuth.

2. The method claimed as in claim 1, wherein the plurality of inputs from the capacity data includes radio frequency (RF) data collected from a plurality of user terminals, customer device information, building data, fibre route, landmarks, a plurality of places of interest and performance of key point index (KPIs), wherein the KPIs comprises of RSRP and SINR.

3. The method claimed as in claim 2, wherein:
the plurality of inputs from the strategy data includes a plurality of user-focused strategies, a plurality of cell-focused strategies, a plurality of area-focused strategies, a plurality of building and point of interest (POI) focused strategies, wherein:
the plurality of user-focused strategies includes high-tariff, mid-range tariff, premium handset users, mid-range handset users, and customers experience;
a plurality of cell-based strategies includes dead cell, ICU cell, hospitalized cells, sick cells, active UE count;
the plurality of area-focused strategies include morphology as dense urban, urban, sub-urban, rural and rail/road network as major roads, railway, lines, highways; and
the plurality of building and POI focused strategies include commercial, residential, high value buildings, POI type such as places of worships, hotels, public services, transport.

4. The method claimed as in claim 1, wherein performing the nominal validation comprising:
processing the plurality of capacity data and strategy data, a target area and the KPI to generate cell level data for each of the nominals, wherein generating cell level data comprises at least in part setting of height, azimuth, tilt of cell;
creating traffic map for the nominals; and
identifying validated nominals based on the cell level data, wherein the validated nominals comprise set of optimal sites and cell configuration.

5. The method claimed as in claim 1, wherein estimating azimuth comprising:
drawing a plurality of points on the site with distance equal to cell radius on an interface;
connecting each of the plurality of points with a nominal center on the interface;
calculating minimum and maximum angle between two points lines; and
determining average of the calculated minimum and maximum angle, wherein the average of the minimum and maximum angle is azimuth of sector.

6. The method claimed as in claim 1, wherein obtaining the plurality of optimized sites comprising:
obtaining sites to be optimized from the plurality of sites;
iterating each site from the sites to be optimized;
estimating coverage gain based on the RSPR and the SINR;
ordering sites based on the coverage gain inside the target area;
prioritizing the sites located in a high traffic density area; and
selecting the sites upto a point defined RSRP and SINR targets are achieved, wherein the selected sites are optimized sites.

7. The method claimed as in claim 1, wherein deploying advanced generation network on the selected optimum sites over existing generation infrastructure or as a new site location, wherein the advanced generation network comprises fifth-generation (5G) and existing generation comprises fourth-generation (4G).

8. The method claimed as in claim 1 further comprising:
on selecting the plurality of optimized sites to deploy the network, deciding a plurality of orientations and a plurality of parameters for the sites, wherein the plurality of orientations includes cell radius, cell range, and grid counts, and wherein the plurality of parameters includes azimuth, tilt, height, and power.

9. A system for performing network planning and deployment, the, the system is configured to:
the AI engine configured to generate a plurality of nominals based at least in part on the plurality of inputs received from strategy data and the capacity data, wherein the plurality of nominals includes a plurality of site locations and corresponding site configurations;
the nominal validation (NV) module configured to perform validation of the plurality of nominals; and
the processing engine configured to:
estimate azimuth for each of the plurality of validated nominals;
obtain a plurality of sites from the estimated azimuth;
select a plurality of optimized sites form the plurality of sites obtained based on the estimated azimuth; and
deploy a network based on the selected optimized sites, wherein the selected optimized sites have optimal values of reference signal received power (RSRP) and a signal to interference and noise ratio (SINR), an optimal count of sites with optimized tilt and azimuth.

10. The system claimed as in claim 9, wherein the plurality of inputs from the capacity data includes crowdsourced radio frequency (RF) data collected from a plurality of user terminals, customer device information, building data, fibre route, landmarks, a plurality of places of interest and performance of key point index (KPIs).

11. The system claimed as in claim 10, wherein:
the plurality of inputs from the NG strategy includes a plurality of user-focused strategies, a plurality of cell-focused strategies, a plurality of area-focused strategies, a plurality of building and point of interest (POI) focused strategies, wherein:
the plurality of user-focused strategies includes high-tariff, mid-range tariff, premium handset users, mid-range handset users, customers experience;
a plurality of cell-based strategies includes dead cell, ICU cell, hospitalized cells, sick cells, active UE count;
the plurality of area-focused strategies include morphology as dense urban, urban, sub-urban, rural and rail/road network as major roads, railway, lines, highways; and
the plurality of building and POI focused strategies include commercial, residential, high value buildings, POI type such as places of worships, hotels, public services, transport.

12. The system claimed as in claim 9, the NV module configured to:
process the plurality of capacity data and strategy data, a target area and the KPI to generate cell level data for each of the nominals, wherein generating cell level data comprises at least in part setting of height, azimuth, tilt of cell;
create traffic map for the nominals; and
identify validated nominals based on the cell level data, wherein the validated nominals comprise set of optimal sites and cell configurations.

13. The system claimed as in claim 9, for estimating azimuth, the processing engine configured to:
draw a plurality of points on the site with distance equal to cell radius on an interface;
connect each of the plurality of points with a nominal center on the interface;
calculate minimum and maximum angle between two points lines; and
determine average of the calculated minimum and maximum angle, wherein average of the minimum and maximum angle is azimuth of sector.

14. The system claimed as in claim 9, wherein for obtaining the plurality of optimized sites, the processing module is configured to:
obtain sites to be optimized from the plurality of sites;
iterate each site from the sites to be optimized;
estimate coverage gain based on the RSPR and the SINR;
order sites based on the coverage gain inside the target area;
prioritize the sites located in a high traffic density area; and
select the sites upto a point defined RSRP and SINR targets are achieved, wherein the selected sites are optimized sites.

15. The system claimed as in claim 9, wherein an advanced generation network is deployed on the selected optimum sites over existing generation infrastructure or as a new site location, wherein the advanced generation network is fifth generation (5G), and existing generation is fourth generation (4G).

16. The system claimed as in claim 9, wherein the system is further configured to: on selecting the plurality of optimized sites to deploy the network, decide a plurality of orientations and a plurality of parameters for the sites, wherein the plurality of orientations includes cell radius, cell range, and grid counts, and the plurality of parameters includes azimuth, tilt, height, and power.

17. A computer program product comprising a non-transitory computer-readable medium comprising instructions that, when executed by one or more processors, cause the one or more processors to perform a method for performing network planning and deployment, the method comprising:
generating, by an artificial intelligence (AI) engine, a plurality of nominals based at least in part on the plurality of inputs from strategy data and capacity data, wherein the plurality of nominals includes a plurality of site locations and their corresponding site configurations;
performing, by a nomination validation module, validation of the plurality of nominals;
estimating azimuth for each of the plurality of validated nominals;
obtaining a plurality of sites from the estimated azimuth;
selecting a plurality of optimized sites from the plurality of sites obtained based on the estimated azimuth; and
deploying a network based on the selected optimized sites, wherein the selected optimized sites have optimal values of reference signal received power (RSRP) and a signal to interference and noise ratio (SINR), an optimal count of sites with optimized tilt and azimuth.
